(19) United States
(12) Patent Application Publication
(10) Pub. No.: US 2022/0163641 A1
(43) Pub. Date: May 26, 2022

(54) MULTIPATH DETECTION DEVICE AND MULTIPATH DETECTION METHOD

(71) Applicant: NUVOTON TECHNOLOGY CORPORATION JAPAN, Kyoto (JP)

(72) Inventors: Megumi NAGATA, Osaka (JP); Keiichi MORI, Osaka (JP)

(21) Appl. No.: 17/360,751

(22) Filed: Jun. 28, 2021

Related U.S. Application Data
(60) Provisional application No. 63/117,177, filed on Nov. 23, 2020.

(51) Int. Cl. G01S 7/4865; G01C 3/06; G01S 17/89

(52) U.S. Cl. CPC G01S 7/4865; G01S 17/89; G01C 3/06

(57) ABSTRACT

A multipath detection device includes: a signal controller; a light emitter; a light receiver; a data holder that holds reference data on a depth in a non-multipath environment; a signal processor that calculates a first depth and a second depth, the first depth being determined based on a ratio between (i) an amount of light received through light exposure during a first timing and (ii) an amount of light received through light exposure during a second timing, the second depth being determined based on a ratio between (iii) an amount of light received through light exposure during a third timing and (iv) an amount of light received through light exposure during a fourth timing; and a determiner that determines presence or absence of multipath using the reference data and a difference between the first depth and the second depth.

### CROSS REFERENCE TO RELATED APPLICATION

The present application is based on and claims priority of U.S. Provisional Patent Application No. 63/117,177 filed on Nov. 23, 2020. The entire disclosure of the above-identified application, including the specification, drawings and claims is incorporated herein by reference in its entirety.

### FIELD

The present disclosure relates to a multipath detection device and a multipath detection method for detecting the presence or absence of multipath when measuring a distance to a measurement target.

### BACKGROUND

A conventional time-of-flight (TOF) camera system which measures a distance to a measurement target based on a time of flight taken by light to travel to and back from the measurement target is known. With this TOF camera system, measurement error increases and measurement precision deteriorates when there is a mixture of direct light that travels back directly from the measurement target and indirect light that travels back via an object different from the measurement target. To address this, Non-Patent Literature (NPL) 1, for example, proposes a TOF camera system which reduces the influence of multipath.

### CITATION LIST

### Non Patent Literature

NPL 1: D. Freedman, E. Krupka, Y. Smolin, I. Leichter, and M. Schmidt, “SRA: Fast removal of general multipath for ToF sensors.” In Proceedings of the 13th European Conference on Computer Vision (ECCV'14), pp, 234-249.

### SUMMARY

### Technical Problem

To reduce the influence of multipath, it is necessary to determine whether the measurement environment is a multipath environment in which both direct light and indirect light are present, and then perform processing according to the presence or absence of multipath. The TOF camera system disclosed in NPL 1, however, has a problem that it involves a great amount of calculation for determining the presence or absence of multipath, that is, the processing load is heavy.

### Solution to Problem

A multipath detection device according to the present disclosure includes: a signal controller that outputs a light emission control signal and a light exposure control signal; a light emitter that emits light in accordance with the light emission control signal; a light receiver that receives light through light exposure in accordance with the light exposure control signal; a data holder that holds reference data on a depth determined based on a ratio between: an amount of light received by the light receiver through light exposure in a non-multipath environment during a predetermined timing in accordance with a predetermined light emission control signal output from the signal controller; and an amount of light received by the light receiver through light exposure in the non-multipath environment during a timing different from the predetermined timing in accordance with the light emission control signal output from the signal controller in a time slot different from a time slot in which the predetermined light emission control signal is output; a signal processor that calculates a first depth and a second depth, the first depth being determined based on a ratio between (i) an amount of light received by the light receiver through light exposure during a first timing in accordance with a first light emission control signal output from the signal controller and (ii) an amount of light received by the light receiver through light exposure during a second timing different from the first timing in accordance with a second light emission control signal output from the signal controller in a time slot different from a time slot in which the first light emission control signal is output, the second depth being determined based on a ratio between (iii) an amount of light received by the light receiver through light exposure during a third timing in accordance with a third light emission control signal output from the signal controller and (iv) an amount of light received by the light receiver through light exposure during a fourth timing different from the third timing in accordance with a fourth light emission control signal output from the signal controller in a time slot different from a time slot in which the third light emission control signal is output; and a determiner that determines presence or absence of multipath using the reference data and a difference between the first depth and the second depth.

A multipath detection method according to the present disclosure includes: storing reference data on a depth determined based on a ratio between: an amount of light received through light exposure in a non-multipath environment during a predetermined timing in accordance with a predetermined light emission control signal; and an amount of light received through light exposure in the non-multipath environment during a timing different from the predetermined timing in accordance with a light emission control signal output in a time slot different from a time slot in which the predetermined light emission control signal is output; calculating a first depth based on a ratio between (i) an amount of light received through light exposure during a first timing in accordance with a first light emission control signal and (ii) an amount of light received through light exposure during a second timing different from the first timing in accordance with a second light emission control signal output in a time slot different from a time slot in which the first light emission control signal is output; calculating a second depth based on a ratio between (hi) an amount of light received through light exposure during a third timing in accordance with a third light emission control signal and (iv) an amount of light received through light exposure during a fourth timing different from the third timing in accordance with a fourth light emission control signal output in a time slot different from a time slot in which the third light emission control signal is output; and determining presence or absence of multipath using the reference data and a difference between the first depth and the second depth.

### Advantageous Effects

With a multipath detection device and a multipath detection method according to the present disclosure, it is possible to reduce the processing load for determination of the presence or absence of multipath.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating an exemplary configuration of a typical distance information obtaining device.

FIG. 2 is a timing diagram illustrating an example of operations of a distance information obtaining device in a non-multipath environment.

FIG. 3 is a timing diagram illustrating another example of operations of a distance information obtaining device in a non-multipath environment.

FIG. 4 illustrates an example of a multipath environment in which both direct light and indirect light are present,

FIG. 5 is a timing diagram illustrating an example of operations of a distance information obtaining device in a multipath environment.

FIG. 6 is a timing diagram illustrating an example of actual operations of a distance information obtaining device in a non-multipath environment.

FIG. 7A is a graph illustrating a time waveform of the emission intensity of irradiation light.

FIG. 7B is a graph illustrating a time waveform of the amount of reflected light received in a non-multipath environment.

FIG. 7C is a graph illustrating a relationship between depth and light round-trip time from emission of irradiation light to reception of reflected light in a non-multipath environment.

FIG. 7D is a graph illustrating a relationship between the depth and depth slope shown in FIG. 7C.

FIG. 8 is a timing diagram illustrating an example of operations of a distance information obtaining device in a multipath environment in which indirect reflected light travels back later than direct reflected light.

FIG. 9A is a graph illustrating time waveforms of received-light intensities of direct reflected light and indirect reflected light in the multipath environment illustrated in FIG. 8.

FIG. 9B is a graph illustrating a time waveform of the amount of light received of mixed reflected light that is a sum of direct reflected light and indirect reflected light.

FIG. 9C is a graph illustrating a relationship between depth and light round-trip time from emission of irradiation light to reception of mixed reflected light in the multipath environment illustrated in FIG. 8.

FIG. 9D is a graph illustrating a relationship between the depth and depth slope shown in FIG. 9C.

FIG. 10 illustrates an example of a multipath environment in which indirect reflected light travels back earlier than direct reflected light.

FIG. 11 is a timing diagram illustrating an example of operations of a distance information obtaining device in a multipath environment in which indirect reflected light travels back earlier than direct reflected light.

FIG. 12A is a graph illustrating time waveforms of received-light intensities of direct reflected light and indirect reflected light in the multipath environment illustrated in FIG. 11.

FIG. 12B is a graph illustrating a time waveform of mixed reflected light that is a sum of direct reflected light and indirect reflected light.

FIG. 12C is a graph illustrating a relationship between depth and light round-trip time from emission of irradiation light to reception of mixed reflected light in the multipath environment Illustrated in FIG. 11.

FIG. 12D is a graph illustrating a relationship between the depth and depth slope shown in FIG. 12C,

FIG. 13A is an explanatory diagram illustrating a situation in which a plurality of rays of indirect light are generated.

FIG. 13B is a graph illustrating time waveforms of amounts of the plurality of rays of indirect light received.

FIG. 13C is a graph illustrating a time waveform of a total amount of the plurality of rays of indirect light received.

FIG. 14 is a block diagram illustrating an exemplary configuration of a multipath detection device according to Working Example 1.

FIG. 15 is a timing diagram illustrating operations of the multipath detection device according to Working Example 1.

FIG. 16 is a flowchart illustrating a multipath detection method according to Working Example 1.

FIG. 17 is a timing diagram illustrating operations of a multipath detection device according to a variation of Working Example 1.

FIG. 18 is a block diagram illustrating an exemplary configuration of a multipath detection device according to Working Example 2.

FIG. 19 is a timing diagram illustrating operations of the multipath detection device according to Working Example 2.

FIG. 20 is a flowchart illustrating a multipath detection method according to Working Example 2.

### DESCRIPTION OF EMBODIMENT

Hereinafter, an embodiment will be specifically described with reference to the accompanying drawings. Note that the embodiment described below illustrates a specific example of the present disclosure. The numerical values, shapes, materials, constituent elements, the arrangement and connection of the constituent elements, steps, the processing order of the steps, etc. illustrated in the embodiment below are mere examples, and are therefore not intended to limit the present disclosure. Among the constituent elements indicated in the embodiment below, those not recited in any of the independent claims representing forms of realization according to an aspect of the present disclosure will be described as optional constituent elements. The forms of realization of the present disclosure are not limited to the current independent claims, and can be represented by other independent claims.

The drawings are represented schematically and are not necessarily precise illustrations. In the drawings, essentially the same constituent elements are given the same reference signs, and overlapping descriptions thereof may be omitted or simplified.

### (Knowledge Forming the Basis of the Present Disclosure)

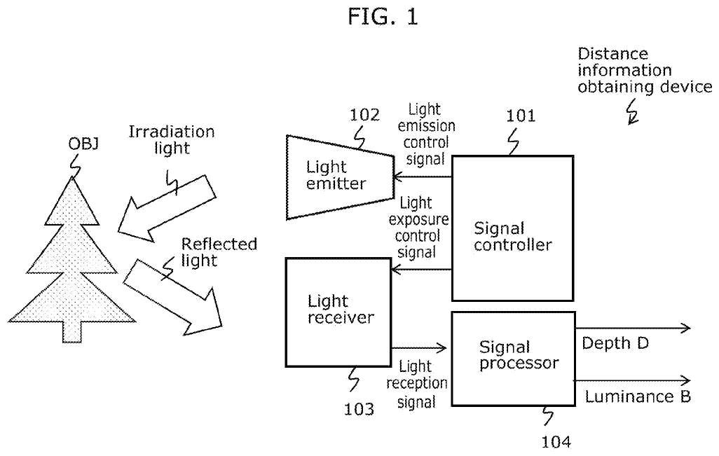

The following describes the knowledge forming the basis of the present disclosure with reference to FIG. 1 to FIG. 13C. The knowledge forming the basis of the present disclosure includes new knowledge not found in the conventional technology as well as conventional knowledge forming the basis of the new knowledge.

### 1. Typical Distance Information Obtaining Device

First, a typical distance information obtaining device will be described with reference to FIG. 1.

FIG. 1 is a block diagram illustrating an exemplary configuration of a typical distance information obtaining device. Note that FIG. 1 shows object OBJ which is a measurement target.

The distance information obtaining device is a time-of-flight (TOF) distance measurement device that measures the distance to a measurement target based on time of flight taken by light to travel to and back from the measurement target. The distance information obtaining device includes signal controller 101, light emitter 102, light receiver 103, and signal processor 104.

Signal controller 101 outputs, to light emitter 102, a light emission control signal that controls light emission performed by light emitter 102. Signal controller 101 also outputs, to light receiver 103, a light exposure control signal that controls light exposure performed by light receiver 103.

In accordance with an emission pulse of the light emission control signal, light emitter 102 emits light, that is, emits irradiation light. The irradiation light is near-infrared light, for example. The irradiation light reflects off object OBJ and travels back to the distance information obtaining device as reflected light.

Light receiver 103 is a solid-state imaging element that includes a plurality of pixels arranged in rows and columns. Light receiver 103 receives reflected light in accordance with an exposure pulse of the light exposure control signal, and outputs a light reception signal to signal processor 104.

Signal processor 104 calculates depth D and luminance B for each pixel of light receiver 103 based on a light reception signal sequence obtained through three types of emission and exposure processing which will be described later. A distance can be calculated based on depth D. The method for calculating depth D and luminance B will be described later.

Next, operations of the distance information obtaining device in a non-multipath environment will be described. Note that the non-multipath environment refers to an environment in which no indirect light is present and only direct light is present,

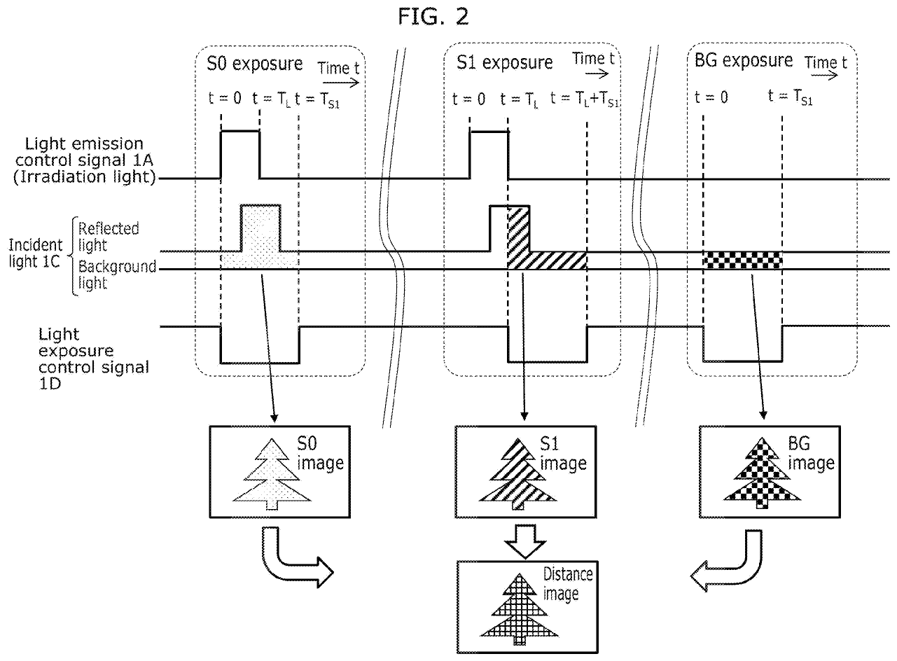

FIG. 2 is a timing diagram illustrating an example of operations of the distance information obtaining device in a non-multipath environment.

FIG. 2 illustrates a waveform of light emission control signal (or irradiation light) 1A having an emission puke, a waveform of incident light 1C that enters light receiver 103, and a waveform of light exposure control signal 1D having an exposure puke. The waveform of incident light 1C is represented by an amount of the light reception signal received by light receiver 103. Note that this example assumes that the shapes of the waveforms of the light emission control signal and the irradiation light are substantially the same.

The emission pulse is the positive logic that represents active when it is high level, whereas the exposure pulse is the negative logic that represents active when it is low level. Incident light 1C includes background light and reflected light that is a portion of the irradiation light that travels to object OBJ and travels back by being reflected by object OBJ. The reflected light enters light receiver 103 with a delay of a predetermined time period from the start of emission of the irradiation light. This delay time period depends on the distance from the distance information obtaining device to object OBJ. The (one) dot hatching region and the (two) diagonally shaded hatching regions of incident light 1C illustrated in FIG. 2 correspond to the amount of the light reception signal of each pixel.

The emission and exposure processing performed for distance measurement is implemented through, for example, S0 exposure in which light emission and light exposure are performed, S1 exposure in which light emission and light exposure are performed in a time slot different from the S0 exposure, and BG exposure in which light emission and light exposure are performed in a time slot different from the S0 exposure and the S1 exposure. Note that in the S0 exposure and the S1 exposure, the start time t of light emission control signal 1A is 0, whereas in the BG exposure, the start time t of light exposure control signal 1D is 0.

In the S0 exposure, the exposure pulse becomes active at the same time as the start of the emission pulse. In other words, the light exposure starts simultaneously with the light emission (t=0). Pulse width T_{S1} of the exposure pulse is set to be twice or more than twice as large as pulse width T_{L} of the emission pulse. In the S0 exposure, the entirety of the reflected light can be received, for example.

In the S1 exposure, the exposure pulse becomes active at the same time as the end of the emission pulse. In other words, the light exposure starts when the light emission ends (t=T_{L}). Pulse width T_{S1} of the exposure pulse is the same as the pulse width in the S0 exposure. In the S1 exposure, of the entire reflected light, reflected light that has entered after the end of the emission pulse can be received, for example.

In the BG exposure, the exposure pulse becomes active with no generation of the emission pulse. In other words, in the BG exposure, background light, which does not include the reflected light, is received. Pulse width T_{S1} of the exposure pulse is the same as the pulse width in the S0 exposure and the S1 exposure.

Note that, in practice, each processing in the S0 exposure, S1 exposure, and BG exposure is performed using a plurality of emission pulses or a plurality of exposure pulses. FIG. 2 illustrates a result of accumulation of each processing.

Signal processor 104 calculates distance L and luminance B for each pixel, using the amount of the light reception signal (the amount of signal charge generated by light reception) of the pixel in the S0 exposure, S1 exposure, and BG exposure.

Here, distance L of each pixel is calculated by Equation 1, where amount of light received S0, amount of light received S1, and amount of light received BG denote the amount of the light reception signal of each pixel in the S0 exposure, the amount of the light reception signal of each pixel in the S1 exposure, and the amount of the light reception signal of each pixel in the BG exposure, respectively. Depth D is the second term on the right side of Equation 1, and is calculated by dividing the amount of light received (S1−BG) by the amount of light received (S0−BG). Luminance B of each pixel is calculated by Equation 2. Note that c denotes the light speed (approximately 299,792,458 m/s) and T_{L} denotes the puke width of the emission pulse.

$$\begin{matrix}[ Formula 1 ] & \\ L = \frac{c \times {T}_{L}}{2} \times \frac{S 1 - BG}{S 0 - BG} & Equation 1 \\ [ Formula 2 ] & \\ B = S 0 - BG & Equation 2\end{matrix}$$

Next, another example of operations of the distance information obtaining device in a non-multipath environment will be described.

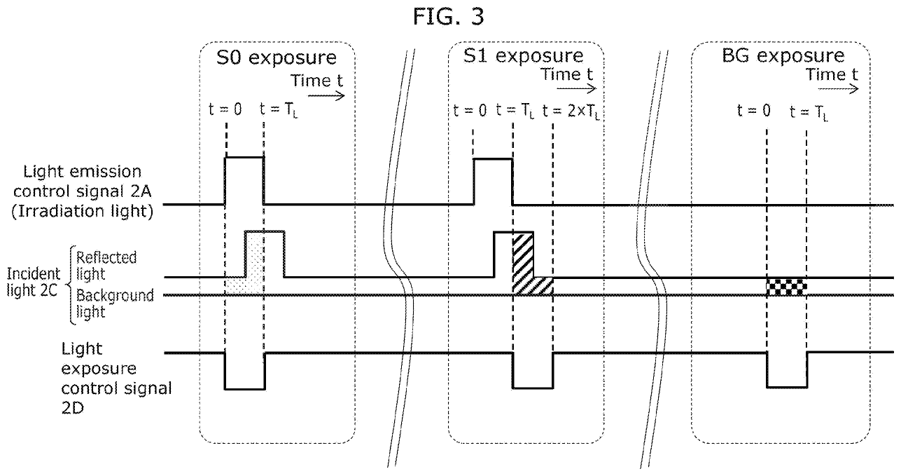

FIG. 3 is a timing diagram illustrating another example of operations of the distance information obtaining device in a non-multipath environment.

FIG. 3 illustrates a waveform of light emission control signal (or irradiation light) 2A, a waveform of incident light 2C, and a waveform of light exposure control signal 2D. The example illustrated in FIG. 3 is different from the example illustrated in FIG. 2 in that the pulse width of the exposure pulse is the same as the pulse width of the emission pulse. In this case, distance L of each pixel is calculated by Equation 3, and luminance B by Equation 4.

$$\begin{matrix}[ Formula 3 ] & \\ L = \frac{c \times {T}_{L}}{2} \times \frac{S 1 - BG}{( S 0 - BG ) \times ( S 1 - BG )} & Equation 3 \\ [ Formula 4 ] & \\ B = ( S 0 - BG ) + ( S 1 - BG ) & Equation 4\end{matrix}$$

### 2, Mechanism of Measurement Error

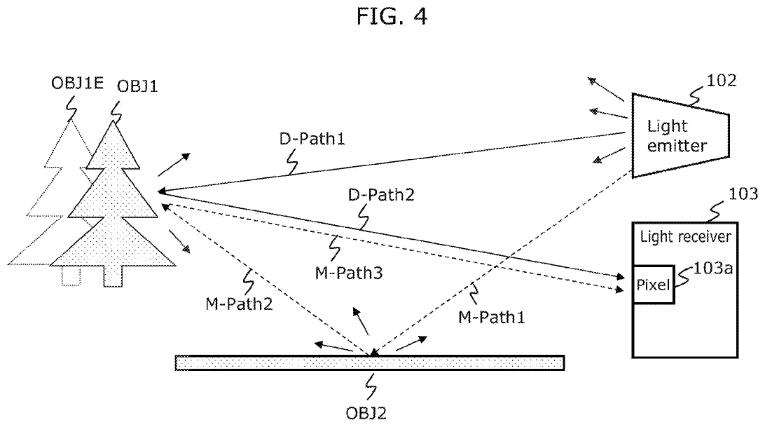

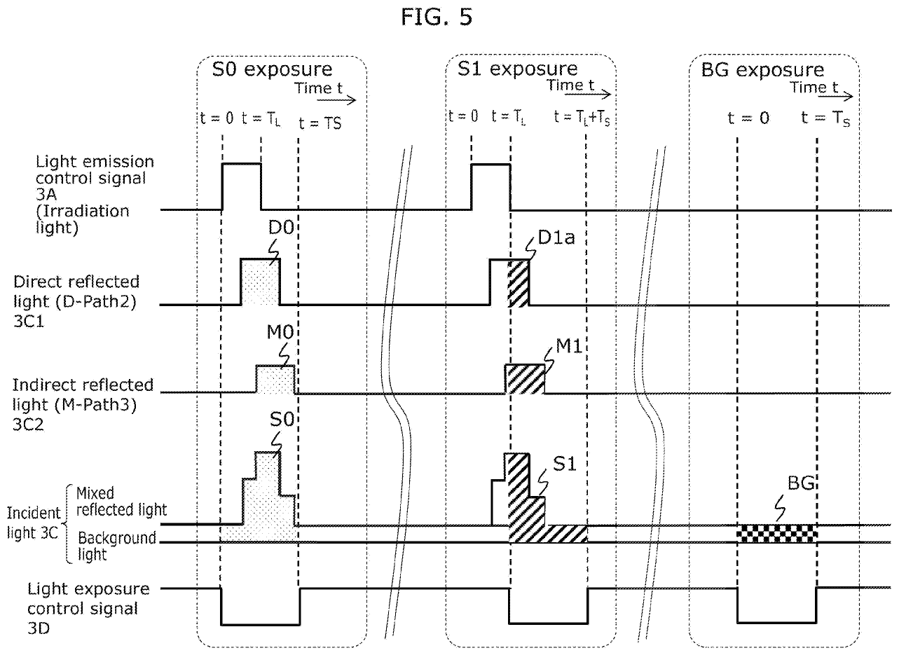

Next, the mechanism of how measurement errors occur in a multipath environment will be described with reference to FIG. 4 and FIG. 5.

FIG. 4 illustrates an example of a multipath environment in which both direct light and indirect light are present.

Object OBJ1 illustrated in FIG. 4 is the measurement target, and object OBJ2 is the cause of indirect light. Distance measurement result OBJ1E is an image formed due to a measurement error caused by multipath when the distance information obtaining device carries out measurement on object OBJ1.

FIG. 4 illustrates the paths of direct light and indirect light. The path of direct light is a path passing through object OBJ1, and is a path along which: direct irradiation light (D−Path1) becomes direct reflected light (D−Path2) by being reflected by object OBJ1; and the direct reflected light (D−Path2) reaches pixel 103a of light receiver 103.

The path of indirect light is a path passing through object OBJ2 and object OBJ1, and is a path along which: indirect irradiation light (M−Path1) becomes indirect irradiation light (M−Path2) by being reflected by object OBJ2 and further becomes indirect reflected light (M−Path3) by being reflected by object OEM; and the indirect reflected light (M−Path3) reaches pixel 103a of light receiver 103.

FIG. 5 is a timing diagram illustrating an example of operations of the distance information obtaining device in a multipath environment.

FIG. 5 illustrates a waveform of light emission control signal (or irradiation light) 3A, a waveform of direct reflected light (D−Path2) 3C1, a waveform of indirect reflected light (M−Path3) 3C2, a waveform of mixed reflected light that is a sum of direct reflected light 3C1 and indirect reflected light 3C2, and a waveform of light exposure control signal 3D. Among these, the waveforms of light emission control signal 3A, direct reflected light 3C1, and light exposure control signal 3D are the same as the waveforms of light emission control signal 2A, incident light 2C, and light exposure control signal 2D illustrated in FIG. 2. That is to say, FIG. 5 is FIG. 2 plus the waveforms of indirect reflected light 3C2 and mixed reflected light.

Amount of light received S0 in the S0 exposure is a sum of amount of light received D0 corresponding to direct reflected light 3C1 and amount of light received M0 corresponding to indirect reflected light 3C2. Likewise, amount of light received S1 in the S1 exposure is a sum of amount of light received D1a corresponding to direct reflected light 3C1 and amount of light received M1 corresponding to indirect reflected light 3C2. With these plugged into Equation 1, distance L of each pixel can be given by Equation 5.

$$[ Formula 5 ]$$

$$L = \frac{c \times {T}_{L}}{2} \times \frac{D 1 a + M 1 - BG}{D 0 + M 0 - BG} \qquad Equation 5$$

The following describes the result of application of the above example to the other example in FIG. 3 in which the exposure pulse and the emission pulse have the same pulse width. That is to say, amount of light received S0 in the S0 exposure is a sum of amount of light received D0 corresponding to direct reflected light 3C1 and amount of light received M0 corresponding to indirect reflected light 3C2, whereas amount of light received S1 in the S1 exposure is a sum of amount of light received D1a corresponding to direct reflected light 3C1 and amount of light received M1 corresponding to indirect reflected light 3C2. With these plugged into Equation 3, distance L of each pixel in the example case illustrated in FIG. 3 can be calculated by Equation 6.

$$[ Formula 6 ]$$

$$L = \frac{c \times {T}_{L}}{2} \times \frac{D 1 a + M 1 - BG}{( D 0 + M 0 - BG ) + ( D 1 a + M 1 - BG )} \qquad Equation 6$$

Amounts of light received M0 and M1 corresponding to indirect reflected light 3C2 in Equation 5 are values dependent not only on the distance to object OBJ1 but also on the location and reflectance of a peripheral object. Thus, distance L calculated by Equation 5 includes an unpredictable measurement error and causes deterioration of the measurement accuracy in small or large degrees. The same applies to Equation 6.

### 3. Actual Operations of Distance Information Obtaining Device

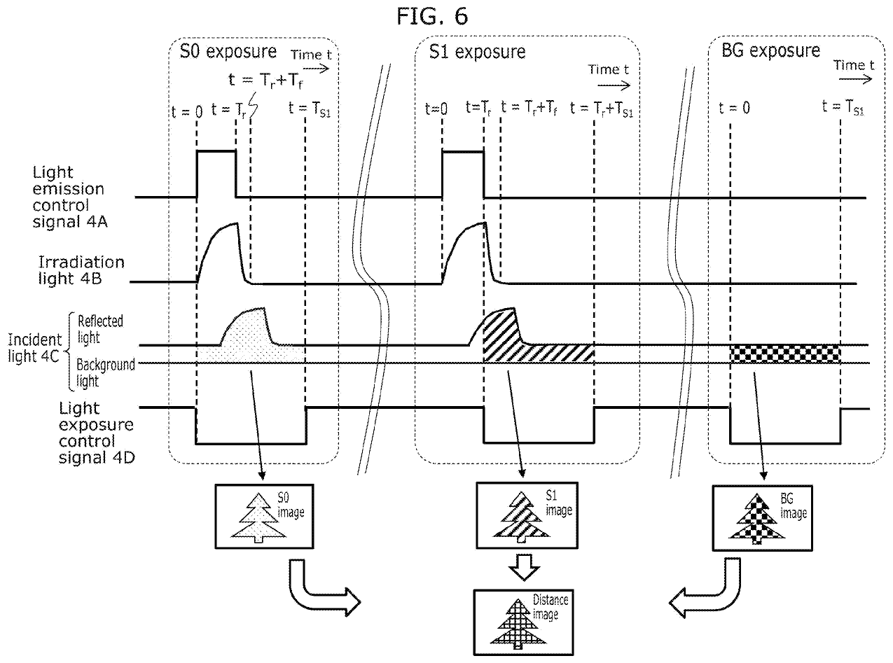

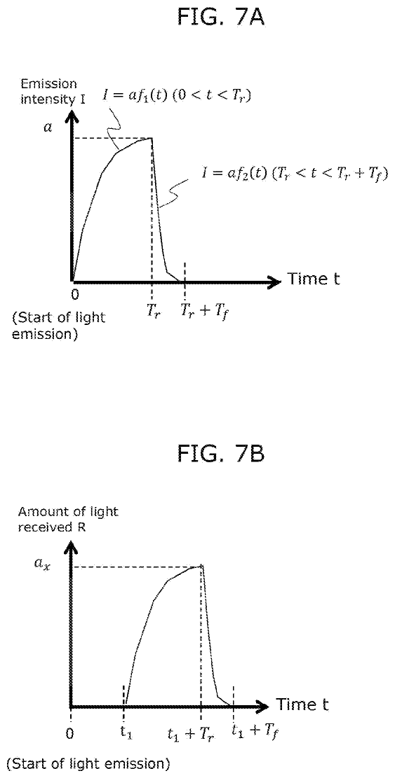

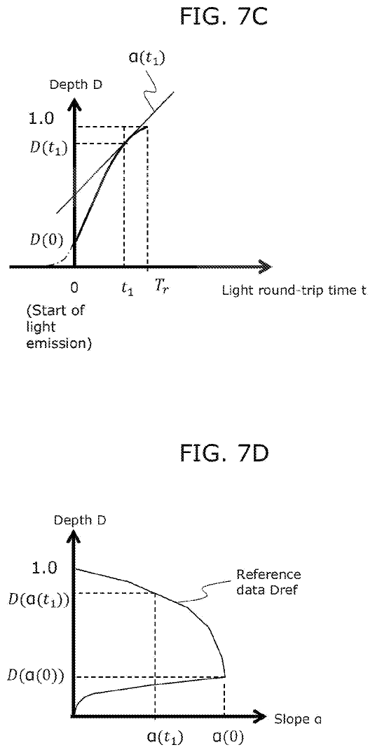

Next, actual operations of the distance information obtaining device will be described with reference to FIG. 6 to FIG. 7C. Note that a non-multipath environment will be described here.

FIG. 6 is a timing diagram illustrating an example of actual operations of the distance information obtaining device in a non-multipath environment.

FIG. 6 illustrates a waveform of light emission control signal 4A, a waveform of irradiation light 4B, a waveform of incident light 4C, and a waveform of light exposure control signal 4D. Among these, the waveforms of light emission control signal 4A and light exposure control signal 4D are the same as the waveforms of light emission control signal 1A and light exposure control signal 1D illustrated in FIG. 2. That is to say, FIG. 6 is FIG. 2 plus the waveform of irradiation light 4B, The waveforms of irradiation light 4B and incident light 4C illustrated in FIG. 6 are waveforms resulting from distortion of pulse waveforms generated in actual operations.

Light emission control signal 4A is a control signal that causes light emission to start at time t=0 and finish at time t=Tᵣ. Correspondingly, the waveform of irradiation light 4B actually emitted from light emitter 102 gradually rises from start time t=0, gradually falls from finish time t=Tᵣ, and reaches the bottom at time t=Tᵣ+T_{f}. Time Tᵣ corresponds to the pulse rising period, whereas time T_{f} corresponds to the puke falling period.

The rising period and the falling period are generated by a control circuit of the distance information obtaining device. The reason why the rising period and the falling period are taken into consideration is because the puke width of the emission pulse according to the present disclosure is of the order of nanoseconds (nsec). For example, when measuring a distance of from 0 m to 3 m, since the round-trip time of light is approximately 20 nsec, the puke width of the emission puke needs to be set to 20 nsec. When the puke width of the emission puke is short as in this case, the rising period and the falling period cannot be ignored. Thus, in practice, the waveform of irradiation light 4B emitted by light emitter 102 becomes a distorted puke waveform that monotonically increases and then monotonically decreases as illustrated in FIG. 6. Note that the waveform of irradiation light 4B may be shown with a triangular waveform or a sawtooth waveform. As described above, since the waveform of irradiation light 4B is a pulse waveform having a rising period and a falling period, the waveform of incident light 4C also has a rising period and a falling period. In the present disclosure, the shape of this waveform is used to detect the presence or absence of multipath.

FIG. 7A is a graph illustrating a time waveform of emission intensity I of irradiation light 4B.

As illustrated in FIG. 7A, emission intensity I at time (point in time) t is expressed by Equations 7 to 10, given that emission start time t of irradiation light 4B is 0.

$$\begin{matrix}[ Formula 7 ] & \\ I = af ( t ) & Equation 7 \\ [ Formula 8 ] & \\ f ( t ) = {f}_{1} ( t ) = 1 - exp ( \frac{- t}{{τ}_{r}} ) ( 0 \leq t \leq {T}_{r} ) & Equation 8 \\ [ Formula 9 ] & \\ f ( t ) = {f}_{2} ( t ) = exp ( \frac{- t + {T}_{r}}{{τ}_{f}} ) ( {T}_{r} < t \leq {T}_{r} + {T}_{f} ) & Equation 9 \\ [ Formula 10 ] & \\ f ( t ) = 0 ( t < 0 , {T}_{r} + {T}_{f} < t ) & Equation 10\end{matrix}$$

In Equation 8, Tᵣ denotes time constant for the rising of the emission pulse. In Equation 9, T_{f} denotes time constant for the falling of the emission pulse, Tᵣ denotes a rising period, and T_{f} denotes a falling period, and a denotes emission intensity at the start of falling. As for the waveform in the graph illustrated in FIG. 7A, time constant Tᵣ=3.0 nsec, time constant T_{f}=1.4 nsec, rising period Tᵣ=12.7 nsec, and falling period T_{f}=7.3 nsec.

FIG. 7B is a graph illustrating a time waveform of the amount of reflected light received in a non-multipath environment. Note that the amount of reflected light received is an amount of light obtained by subtracting background light from incident light 4C in FIG. 6.

As illustrated in FIG. 7B, amount of light received R_{direct} at time (point in time) t is expressed by Equation 11, given that emission start time t of irradiation light 4B is 0 and the light round-trip time of direct light taken by irradiation light 4B to travel to the measurement target and travel back as direct reflected light is t1.

[Formula 11]

R_{direct}(t)=aₜ_{₁}f(t−t₁) Equation 11

In Equation 11, aₜ₁ denotes received-light intensity at the start of falling. Since light attenuates by the square of distance and is dependent on the reflectance of the measurement target, received-light intensity aₜ₁ is an unknown. As indicated by Equation 11, the waveform of amount of light received R_{direct} is a waveform obtained by attenuating, by received-light intensity aₜ₁ which is an unknown, a waveform obtained by shifting waveform f(t) in Equations 8 to 10 by light round-trip time t₁ to and from the measurement target.

Here, amount of light received (S0−BG) which is obtained through the S0 exposure in FIG. 6 is expressed by Equation 12, where T_{S1}=2×(Tᵣ+T_{f}) denotes the pulse width of the exposure pulse in FIG. 6, and S denotes the area size of waveform f(t) when emission intensity I and emission intensity a are 1 in Equation 7.

[Formula 12]

S0−BG=∫₀^{2(T}^{ᵣ}^{+T}^{_{f}}⁾R_{direct}(t)dt=aₜ_{₁}S Equation 12

Amount of light received (S1−BG) which is obtained through the S1 exposure in FIG. 6 is expressed by Equation 13.

$$[ Formula 13 ]$$

$$\begin{matrix}S 1 - BG = {\int }_{{T}_{r}}^{{T}_{r} + 2 ( {T}_{r} + {T}_{f} )} {R}_{direct} ( t ) dt \\ = {a}_{{t}_{1}} ( {\int }_{{T}_{r}}^{{T}_{r} + {t}_{1}} {f}_{1} ( t - {t}_{1} ) dt + {\int }_{{t}_{r} + {t}_{1}}^{{T}_{r} + {T}_{f} + {t}_{1}} {f}_{2} ( t - {t}_{1} ) dt )\end{matrix} \qquad Equation 13$$

As described above, depth D is the second term on the right side of Equation 1, and is calculated by dividing amount of light received (S1−BG) by amount of light received (S0−BG). Thus, when calculating depth D, unknown received-light intensity aₜ₁ is offset, enabling calculation of light round-trip time t₁. Once light round-trip time t₁ is calculated, distance L can be calculated by Equation 14.

$$[ Formula 14 ]$$

$$L = \frac{c \times {t}_{1}}{2} \qquad Equation 14$$

FIG. 7C is a graph illustrating a relationship between depth D and light round-trip time t from the emission of irradiation light 4B to the reception of reflected light in a non-multipath environment, FIG. 7D is a graph illustrating a relationship between depth D and depth slope α shown in FIG. 7C. FIG. 7D will be described in detail later.

In FIG. 7C, a curve passing through coordinates (t₁, D(t₁)) is drawn with a solid line, given that D(0) denotes the depth when light is received with light round-trip time t=0, and D(t₁) denotes the depth when light is received with light round-trip time t=Depth D and light round-trip time t₁ have a one-to-one relationship, and light round-trip time t₁ and distance L also have a one-to-one relationship. Thus, when depth D(t₁) is known, light round-trip time t₁ is also known, and distance L can be calculated by Equation 14. Also, luminance B can be calculated by Equation 12.

When the above example is applied to the other example in FIG. 3 in which the exposure pulse and the emission pulse have the same pulse width, amount of light received (S0−BG) which is obtained through the S0 exposure is calculated by Equation 15 shown below.

[Formula 15]

S0−BG=∫₀^{T}^{ᵣ}R_{direct}(t)dt=aₜ_{₁}(∫₀^{T}^{ᵣ}f₁(t−t₁)dt) Equation 15

Meanwhile, amount of light received S1 which is obtained through the S1 exposure in the other example in FIG. 3 is the same as that in Equation 13 because the amount of reflected light received is the same.

Depth D in the other example in FIG. 3 is the second term on the right side of Equation 3, and is calculated by dividing amount of light received (S1−BG) by a sum of amount of light received (S0−BG) and amount of light received (S1−BG). Equation 16 is given by adding Equation 15 and Equation 13 that form the denominator of the second term on the right side of Equation 3.

[Formula 16]

(S0−BG)−(S1−BG)=aₜ_{₁}S Equation 16

Because Equation 16 is equal to Equation 12, distance L can be calculated by Equation 14 in the same manner. Note that luminance B can be calculated by Equation 16.

### 4. Actual Operations of Distance Information Obtaining Device in Multipath Environment

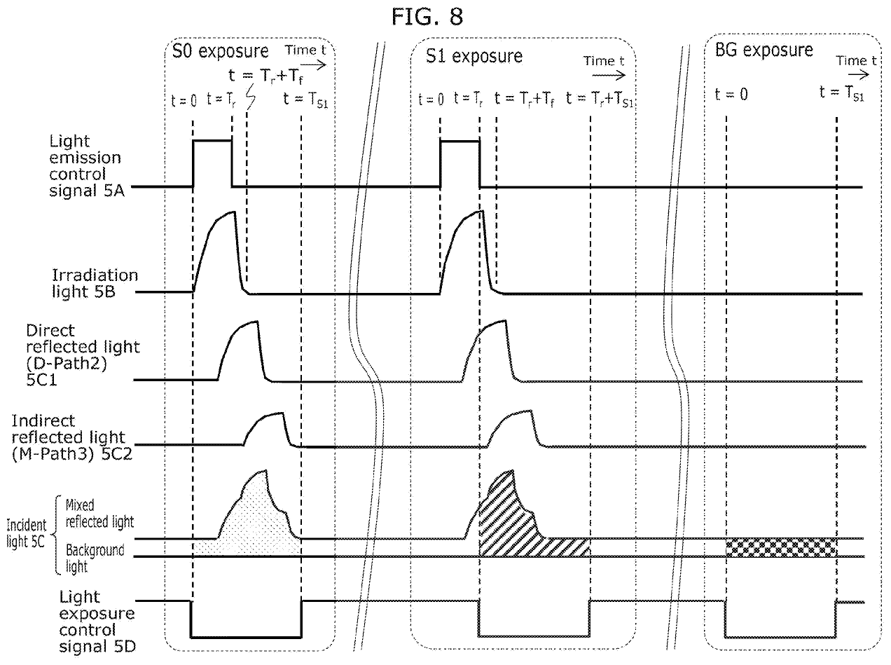

Next, actual operations of the distance information obtaining device in a multipath environment will be described with reference to FIG. 8 to FIG. 13C.

Examples of multipath include a first example in which indirect reflected light reaches light receiver 103 later than direct reflected light, and a second example in which indirect reflected light reaches light receiver 103 earlier than direct reflected light.

First, the first example of multipath will be described.

As illustrated in FIG. 4 described above, multipath occurs when object OBJ2 different from object OBJ1 is located ahead of object OBJ1, and a measurement error is thereby generated.

FIG. 8 is a timing diagram illustrating an example of operations of the distance information obtaining device in a multipath environment in which indirect reflected light travels back later than direct reflected light.

FIG. 8 illustrates a waveform of light emission control signal 5A, a waveform of irradiation light 5B, a waveform of direct reflected light (D−Path2) 5C1, a waveform of indirect reflected light (M−Path3) 5C2, a waveform of incident light 5C, and a waveform of light exposure control signal 5D.

Incident light 5C includes mixed reflected light and background light. The mixed reflected light is a sum of (i) direct reflected light that is a portion of irradiation light 5B that travels to object OBJ1 and travels back through reflection by object OBJ1 and (ii) indirect reflected light that is a portion of irradiation light 53 that travels to object OBJ1 via object OBJ2 and travels back through reflection by object OBJ1. Among these, the waveforms of light emission control signal 5A, irradiation light 53, direct reflected light 5C1, and light exposure control signal 5D are the same as the waveforms of light emission control signal 4A, irradiation light 4B, reflected light of incident light 4C, and light exposure control signal 4D illustrated in FIG. 6. That is to say, FIG. 8 is FIG. 6 plus the waveforms of indirect reflected light 5C2 and incident light 5C,

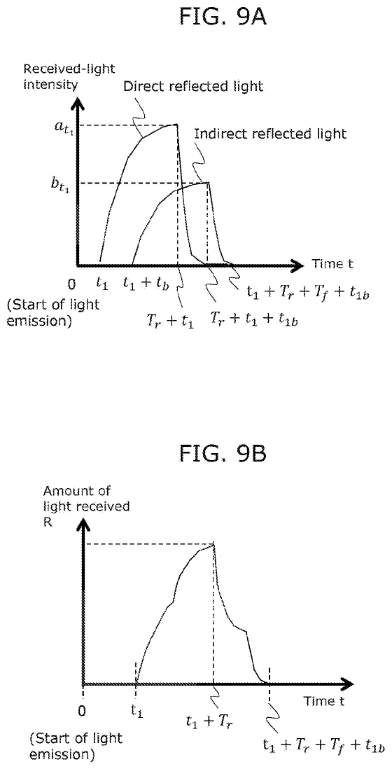

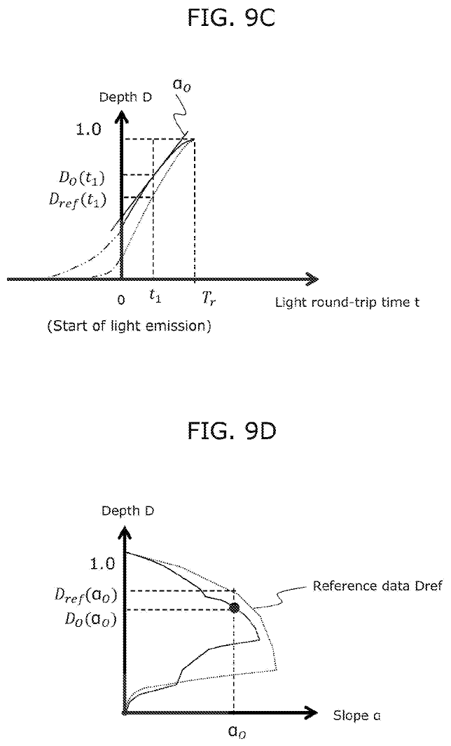

FIG. 9A is a graph illustrating time waveforms of received-light intensities of direct reflected light 5C1 and indirect reflected light 5C2 in the multipath environment illustrated in FIG. 8.

As illustrated in FIG. 9A, indirect reflected light 5C2 is temporally delayed because it travels along a path longer than the path of direct reflected light 5C1. Amount of light received R_{indirect} of indirect reflected light 5C2 at time (point in time) t is expressed by Equation 17, where t₁ denotes the light round-trip time of direct reflected light 5C1 as illustrated in FIG. 7B and Equation 11, and multipath delay time t_{b} denotes delay time of indirect reflected light 5C2 with respect to light round-trip time t₁.

[Formula 17]

R_{indirect}(t)=bₜ_{₁}f(t−t₁−t_{b}) Equation 17

Here, bₜ₁ is the received-light intensity of indirect reflected light 5C2 at the start of falling. Since light attenuates by the square of distance and is dependent on the reflectance of the measurement target and the reflectance of an object located on the path that the light passes through, received-light intensity bₜ₁ is an unknown,

FIG. 98 is a graph illustrating a time waveform of the amount of light received of the mixed reflected light that is a sum of direct reflected light 5C1 and indirect reflected light 5C2. In practice, direct reflected light 5C1 and indirect reflected light 5C2 cannot be received separately as illustrated in FIG. 9A, and thus, the waveform illustrated in FIG. 98 is observed. Amount of light received Rₘᵢₓ of the mixed reflected light at time (point in time) t is expressed by Equation 18.

[Formula 18]

Rₘᵢₓ(t)=R_{direct}(t)+R_{indirect}(t) Equation 18

Here, amount of light received (S0−BG) which is obtained through the S0 exposure in FIG. 8 is expressed by Equation 19, where T_{S1}=2×(Tᵣ+T_{f}) denotes the pulse width of the exposure pulse in FIG. 8, and S denotes the area size of waveform f(t) when emission intensity I and emission intensity a are 1.

[Formula 19]

S0−BG=∫₀^{2(T}^{ᵣ}^{-T}^{_{f)}}{R_{direct}(t)+R_{indirect}(t)}dt=(aₜ_{₁}+bₜ_{₁})S Equation 19

Amount of light received (S1−BG) which is obtained through the S1 exposure in FIG. 8 is expressed by Equations 20 and 21.

$$\begin{matrix} [ Formula 20 ] & \\ S 1 - BG = {\int }_{{T}_{r}}^{{T}_{r} + 2 ( {T}_{r} + {T}_{f} )} \{ {R}_{direct} ( t ) + {R}_{indirect} ( t ) \} dt & Equation 20 \\ [ Formula 21 ] & \\ {\int }_{{T}_{r}}^{{T}_{r} + 2 ( {T}_{r} + {T}_{f} )} {R}_{indirect} ( t ) dt = {b}_{t 1} ( {\int }_{{T}_{r}}^{{T}_{r} + {t}_{1} + {t}_{b}} {f}_{1} ( t - {t}_{1} - {t}_{b} ) dt + {\int }_{{T}_{r} + {t}_{1} + {t}_{b}}^{{T}_{r} + {T}_{f} + {t}_{1} + {t}_{b}} {f}_{2} ( t - {t}_{1} - {t}_{b} ) dt ) & Equation 21\end{matrix}$$

Depth D is the second term on the right side of Equation 1, and is calculated by dividing amount of light received (S1−BG) in Equation 20 by amount of light received (S0−BG) in Equation 19; however, in Equation 21 which is a part of Equations 18 and 20, unknown received-light intensity bₜ₁ is greater than 0, and multipath delay time t_{b} is also greater than 0, which means that the effects of unknown received-light intensity bₜ₁ and multipath delay time t_{b} cannot be offset. As a result, depth D becomes a large value as compared to the value of depth D when only the direct light is received.

FIG. 9C is a graph illustrating a relationship between depth D and light round-trip time t from the emission of irradiation light to the reception of mixed reflected light in the multipath environment illustrated in FIG. 8. FIG. 9D is a graph illustrating a relationship between depth D and depth slope α shown in FIG. 9C.

In FIG. 9C, a curve passing through coordinates (t₁, D₀(t₁)) is drawn with a solid line, given that the depth is 0 when the mixed reflected light is received with light round-trip time t=0, and the depth is D₀(t₁) when the mixed reflected light is received with light round-trip time t=t₁. Also, in FIG. 9C, a curve passing through coordinates (t₁, D_{ref}(t₁)) is drawn with a dotted line, given that the depth is 0 when only direct reflected light 5C1 is received with light round-trip time t=0, and the depth is D_{ref}(t₁) when only direct reflected light 5C1 is received with light round-trip time t=t₁. Note that this dotted line is the same as the curve illustrated in FIG. 7C. With use of these relationships, multipath detection device 100 according to the present disclosure is capable of detecting the presence or absence of multipath by determining whether or not the depth of reflected light is the same as the depth when only the direct light is present, that is, by determining whether or not depth D₀(t₁) is unequal to depth D_{ref}(t₁), as illustrated in FIG. 9D. FIG. 9D will be described in detail later.

Next, the following describes the second example of multipath in which indirect reflected light reaches light receiver 103 earlier than direct reflected light. The second example is also called a flare.

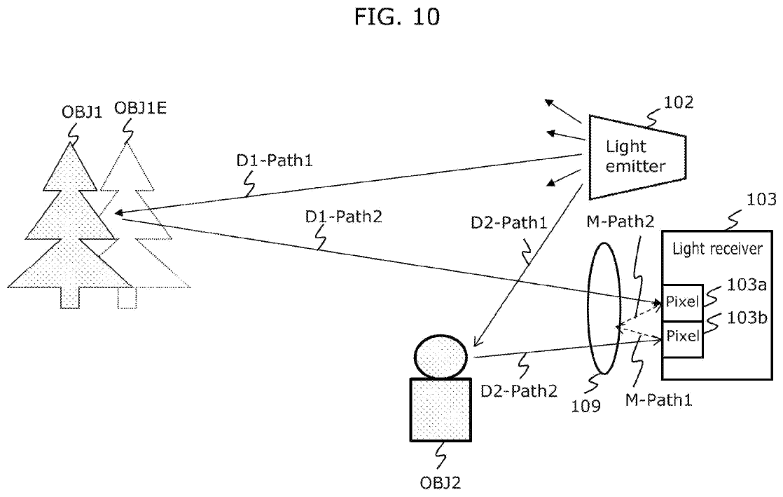

FIG. 10 illustrates an example of a multipath environment in which indirect reflected light travels back earlier than direct reflected light.

In FIG. 10, lens 109 is disposed in front of light receiver 103. Object OBJ1 is the measurement target, and object OBJ2 is the cause of indirect light. Distance measurement result OBJ1E is an image formed due to a measurement error caused by multipath when the distance information obtaining device carries out measurement on object OBJ1.

FIG. 10 illustrates paths of two rays of direct light and a path of a single ray of indirect light.

The path of the first ray of direct light is a path passing through object OBJ1, and is a path along which: direct irradiation light (D1−Path1) becomes direct reflected light (D1−Path2) by being reflected by object OBJ1; and the direct reflected light (D1−Path2) reaches pixel 103a of light receiver 103 via lens 109.

The path of the second ray of direct light is a path passing through object OBJ2, and is a path along which: irradiation light (D2−Path1) becomes reflected light (D2−Path2) by being reflected by object OBJ2; and the reflected light (D2−Path2) reaches pixel 103b of light receiver 103 via lens 109.

The path of the indirect light is a path along which light is reflected by lens 109, that is, a path along which indirect reflected light (M−Path1) reflected by pixel 103b scatters at lens 109 and reaches pixel 103a as indirect reflected light (M−Path2),

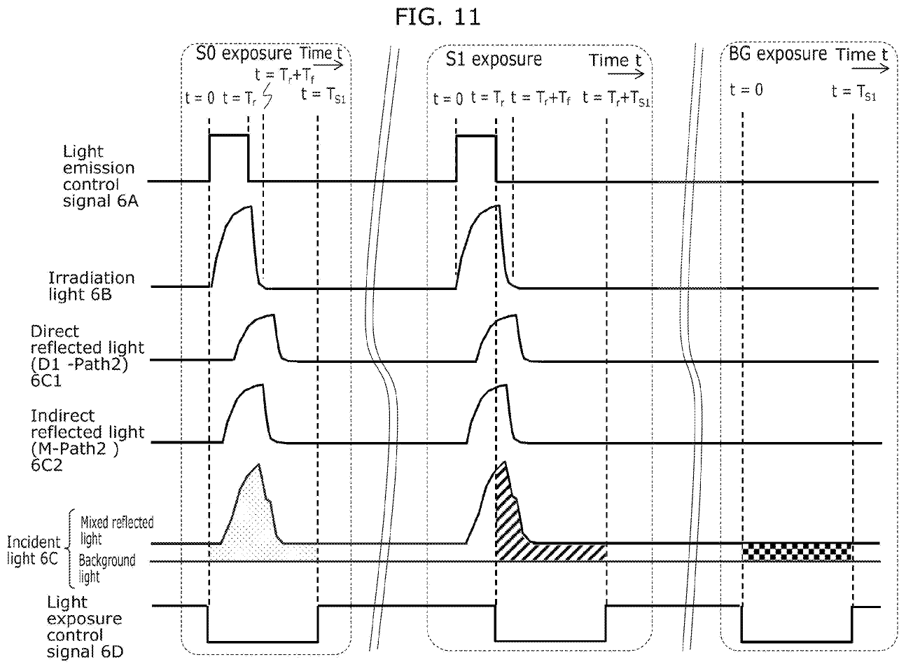

FIG. 11 is a timing diagram illustrating an example of operations of the distance information obtaining device in a multipath environment in which indirect reflected light 6C2 travels back earlier than direct reflected light 6C1,

FIG. 11 illustrates a waveform of light emission control signal 6A, a waveform of irradiation light 6B, a waveform of direct reflected light (D1−Path2) 6C1, a waveform of indirect reflected light (M−Path2) 6C2, a waveform of incident light 6C, and a waveform of light exposure control signal 6D.

Incident light 6C includes mixed reflected light and background light. The mixed reflected light is a sum of direct reflected light 6C1 and indirect reflected light 6C2. Among these, the waveforms of light emission control signal 6A, irradiation light 6B, direct reflected light 6C1, and light exposure control signal 6D are the same as the waveforms of light emission control signal 4A, irradiation light 43, reflected light of incident light 4C, and light exposure control signal 4D illustrated in FIG. 6. That is to say, FIG. 11 is FIG. 6 plus the waveforms of indirect reflected light 6C2 and incident light 6C,

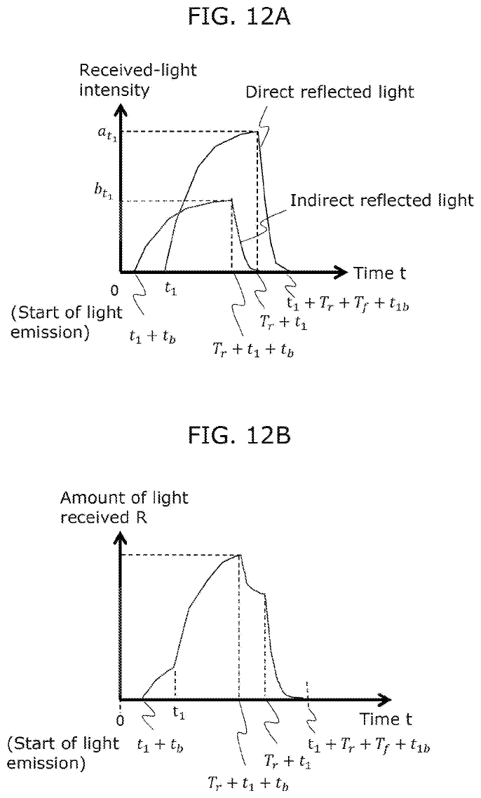

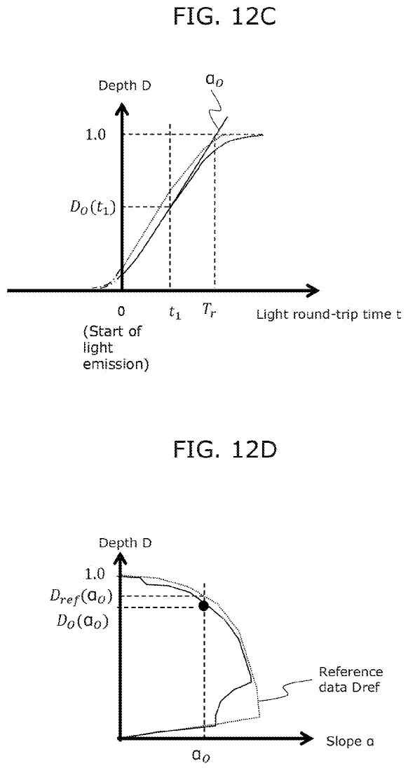

FIG. 12A is a graph illustrating time waveforms of received-light intensities of direct reflected light 6C1 and indirect reflected light 6C2 in the multipath environment illustrated in FIG. 11, FIG. 12B is a graph illustrating a time waveform of mixed reflected light that is a sum of direct reflected light 6C1 and indirect reflected light 6C2.

As illustrated in FIG. 12A, indirect reflected light 6C2 is temporally earlier because it travels along a path shorter than the path of direct reflected light 6C1. Direct reflected light 6C1 is as indicated in Equation 11, and indirect reflected light 6C2, as opposite to the first example in FIG. 7B, travels back earlier by time t_{b}, and thus can be calculated in the same manner by setting unknown time t_{b} to be less than 0 in Equations 17 to 21.

Depth D is the second term on the right side of Equation 1, and is calculated by dividing amount of light received (S1−BG) in Equation 20 by amount of light received (S0−BG) in Equation 19; however, in Equation 21 which is a part of Equations 18 and 20, unknown received-light intensity bₜ₁ is greater than 0, and multipath advance time t_{b} is less than 0, which means that the effects of unknown received-light intensity bₜ₁ and multipath advance time t_{b} cannot be offset. As a result, depth D becomes a small value as compared to the value of depth D when only the direct light is received.

FIG. 12C is a graph illustrating a relationship between depth D and light round-trip time t from the emission of irradiation light 6B to the reception of the mixed reflected light in a multipath environment illustrated in FIG. 11. FIG. 12D is a graph illustrating a relationship between depth D and depth slope α shown in FIG. 12C.

In FIG. 12C, a curve passing through coordinates (t₁, D₀(t₁)) is drawn with a solid line, given that the depth is 0 when the mixed reflected light is received with light round-trip time t=0, and the depth is D₀(t₁) when the mixed reflected light is received with light round-trip time t=t₁. FIG. 12C also illustrates, with a dotted line, the curve shown in FIG. 7C, With use of these relationships, it is possible, also in the second example, to detect the presence or absence of multipath by determining whether or not the depth of reflected light is the same as the depth when only the direct light is present, as illustrated in FIG. 12D. FIG. 12D will be described in detail later.

Note that although the multipath described thus far is the case of including indirect reflected light with a single path, the present disclosure is not limited to this example; the present disclosure also encompasses the case of including indirect reflected light with a plurality of paths as illustrated below.

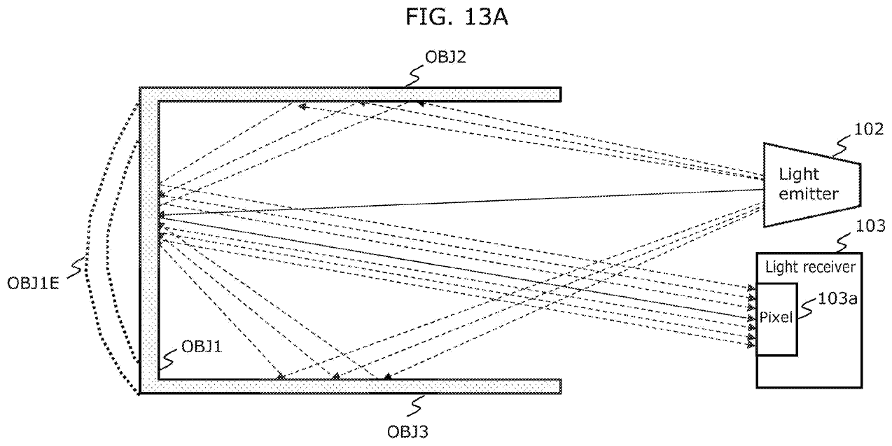

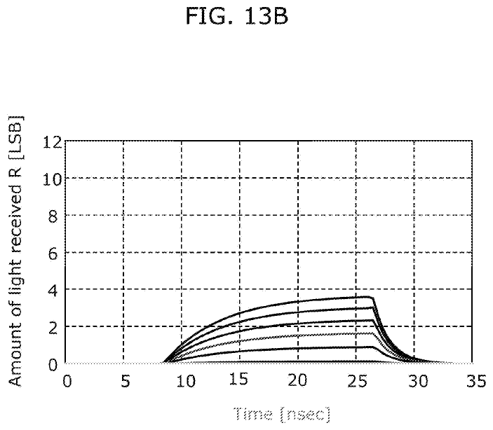

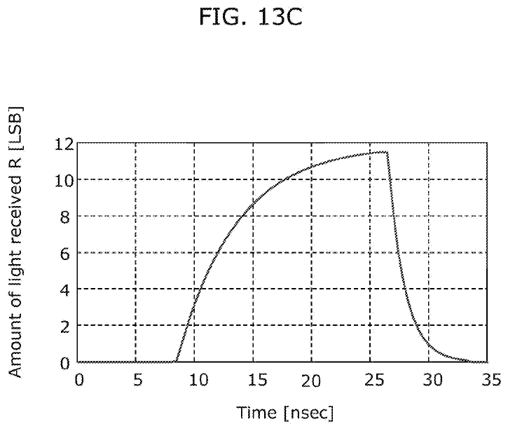

FIG. 13A is an explanatory diagram illustrating a situation in which a plurality of rays of indirect light are generated.

Object OBJ1 illustrated in FIG. 13A is the measurement target, and object OBJ2 and object OBJ3 are the causes of indirect light. Distance measurement result OBJ1E is an image formed due to a measurement error caused by multipath when the distance information obtaining device carries out measurement on object OBJ1. In this diagram, the path of direct light is drawn with a solid line, whereas the paths of three rays of indirect light passing through object OBJ2 and the paths of three rays of indirect light passing through object OBJ3 are drawn with dashed lines.

FIG. 13B is a graph illustrating time waveforms of the amounts of the plurality of rays of indirect light received.

FIG. 13B is a graph illustrating time waveforms of the amounts of light received when the six rays of indirect light in FIG. 13A are assumed to be separately received by light receiver 103. This graph shows that the longer the path of the indirect light is, the later the amount of light received rises and the lower the height of the amount of light received becomes.

FIG. 13C is a graph illustrating a time waveform of a total amount of the plurality of rays of indirect light received.

As illustrated in FIG. 13C, even the waveform representing the total amount of the six rays of indirect light received shows the same waveform tendency as that shown in FIG. 73. Thus, even when a plurality of rays of indirect light are generated, the plurality of rays of indirect light can approximate indirect light of a single path described above. That is to say, the present knowledge can be applied even when a plurality of rays of indirect light are generated.

### 5. Method of Determining the Presence or Absence of Multipath

Next, a method of determining the presence or absence of multipath will be described with reference to FIG. 7D, FIG. 9D, and FIG. 12D. This method of determining the presence or absence of multipath focuses on depth slope α or a difference between two depths.

Slope α(t₁) of depth D is a value obtained by differentiating depth D with respect to predetermined light round-trip time t₁, and is expressed by Equation 22.

$$[ Formula 22 ]$$

$$α ( {t}_{1} ) = \frac{dD ( {t}_{1} )}{{dt}_{1}} = {f}_{1} ( {T}_{r} - {t}_{1} ) * \frac{1}{S} \qquad Equation 22$$

As can be understood from Equation 22, slope α(t₁) is calculated by inverting the waveform in a direction opposite to time t and shifting the waveform by time Tᵣ, and performing normalization to make the waveform area size 1 by the term 1/S.

FIG. 7D is a graph illustrating the relationship between depth D and depth slope α shown in FIG. 7C, with the vertical axis and the horizontal axis reversed. Depth slope α obtained by differentiation of depth D is expressed by Equation 23.

$$[ Formula 23 ]$$

$$\frac{dD ( {t}_{1} )}{{dt}_{1}} = {lim}_{Δ t \to 0} \frac{D ( {t}_{1} ) - D ( {t}_{1} - Δ t )}{Δ t} \qquad Equation 23$$

In Equation 23, depth slope α can be calculated by assigning 0 to Δt, but in reality, it is difficult to assign 0 to Δt, and the influence of noise increases as Δt approaches 0. Thus, Δt is set to a relatively large value, for example. Specifically, Δt is set to, for example, a half or a third of rising period Tᵣ of the emission pulse. Note that instead of using depth slope α, it is possible to use the difference between two depths, with a fixed value given to Δt. This reduces the load of calculation caused by division, thus further enabling reduction in the processing load.

FIG. 9D is a graph illustrating the relationship between depth D and depth slope α shown in FIG. 9C, with the vertical axis and the horizontal axis reversed. FIG. 9D illustrates depth slope α₀ and depth D₀(α₀) when mixed reflected light is received with light round-trip time t=t₁. The dotted line in FIG. 9D shows, as reference data D_{ref}, a relationship between the depth and the depth slope when only direct reflected light shown in FIG. 7D is received.

As illustrated in FIG. 9D, depth D₀(α₀) corresponding to depth slope α₀ calculated with mixed reflected light is different from depth D_{ref}(α₀) corresponding to the same slope α₀. As described above, it is possible to determine the presence or absence of multipath by, for example, holding in advance, as reference data D_{ref}, depth D and its slope α when only direct reflected light is received, and determining whether or not the depth obtained by actual measurement matches reference data D_{ref}.

FIG. 12D is a graph illustrating the relationship between depth D and depth slope α shown in FIG. 12C, with the vertical axis and the horizontal axis reversed. FIG. 12D illustrates depth slope α₀ and depth D₀(α₀) when mixed reflected light is received with light round-trip time t=t₁. The dotted line in FIG. 12D shows, as reference data D_{ref}, a relationship between the depth and the depth slope when only direct reflected light shown in FIG. 7D is received.

As illustrated in FIG. 12D, depth D₀(α₀) corresponding to depth slope α₀ calculated with mixed reflected light is different from depth D_{ref}(α₀) corresponding to the same slope α₀. In the example case of FIG. 12D, too, it is possible to determine the presence or absence of multipath by, for example, holding in advance, as reference data D_{ref}, depth D and its slope α when only direct reflected light is received, and determining whether or not the depth obtained by actual measurement matches reference data D_{ref}.

### Working Example 1

### 1-1. Configuration of Multipath Detection Device

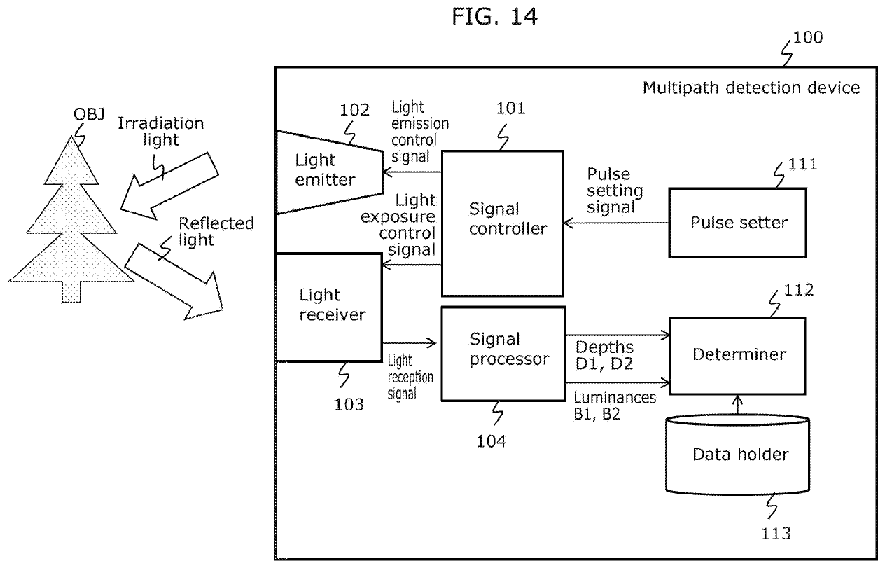

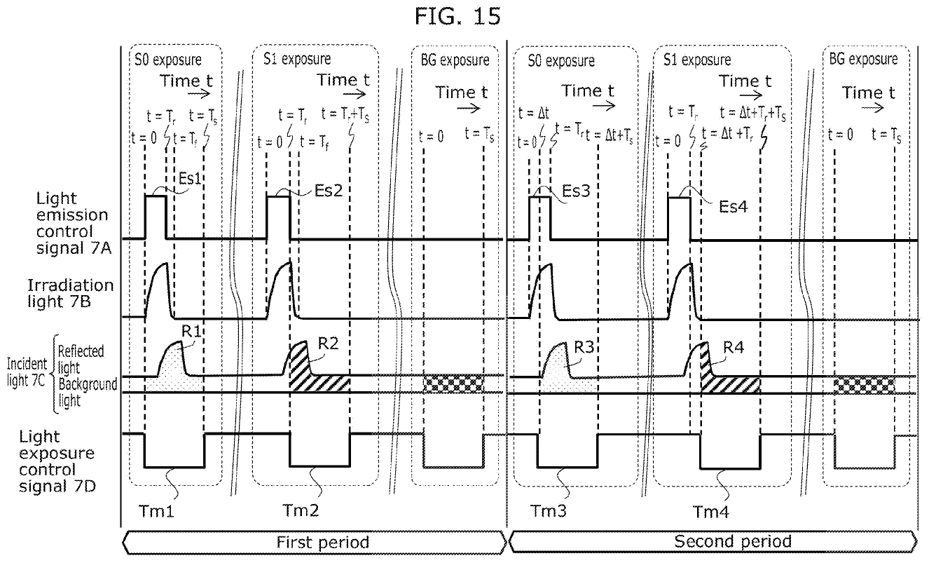

Based on the knowledge forming the basis of the present disclosure, the configuration of multipath detection device 100 according to Working Example 1 will be described with reference to FIG. 14 and FIG. 15.

FIG. 14 is a block diagram illustrating an exemplary configuration of multipath detection device 100 according to Working Example 1. Note that FIG. 14 schematically illustrates object OBJ, irradiation light, and reflected light as well.

Multipath detection device 100 is a TOF distance measurement device. Multipath detection device 100 includes signal controller 101, light emitter 102, light receiver 103, signal processor 104, pulse setter 111, determiner 112, and data holder 113, Note that these functions of multipath detection device 100 are implemented by a microcomputer, a microcontroller, or a digital signal processor (DSP). The microcomputer, microcontroller, or DSP includes memory that stores a program for multipath detection and a central processing unit (CPU) that runs the program.

Pulse setter 111 outputs, to signal controller 101, a pulse setting signal for setting the emission pulse and the exposure pulse.

Signal controller 101 outputs, to light emitter 102, a light emission control signal that controls light emission performed by light emitter 102. Signal controller 101 also outputs, to light receiver 103, a light exposure control signal that controls light exposure performed by light receiver 103.

In accordance with the emission pulse of the light emission control signal, light emitter 102 emits light, that is, emits irradiation light. The irradiation light is near-infrared light, for example. The irradiation light reflects off object OBJ and travels back to multipath detection device 100 as reflected light.

Light receiver 103 is a solid-state imaging element that includes a plurality of pixels arranged in rows and columns. Light receiver 103 receives reflected light in accordance with the exposure pulse of the light exposure control signal, and outputs a light reception signal to signal processor 104.

Signal processor 104 calculates first depth D1, second depth D2, first luminance 31, and second luminance 32 for each pixel of light receiver 103 based on a light reception signal sequence obtained through three types of emission and exposure processing.

FIG. 15 is a timing diagram illustrating operations of multipath detection device 100 according to Working Example 1. FIG. 15 illustrates a waveform of light emission control signal 7A, a waveform of irradiation light 7B, a waveform of incident light 7C, and a waveform of light exposure control signal 7D.

Multipath detection device 100 performs the following exposures to calculate depth slope α: S0 exposure, S1 exposure, and BG exposure that are performed in a first period, and S0 exposure, S1 exposure, and BG exposure that are performed in a second period different from the first period. Note that the settings for the S0 exposure, S1 exposure, and BG exposure in the first period are the same as the settings for the exposures in FIG. 6.

Each of first light emission control signal Es1, second light emission control signal Es2, third light emission control signal Es3, and fourth light emission control signal Es4 illustrated in FIG. 15 is a light emission control signal that is output from signal controller 101. Signal controller 101 outputs first light emission control signal Es1 and second light emission control signal Es2 in different time slots in the first period, and outputs third light emission control signal Es3 and fourth light emission control signal Es4 in different time slots in the second period.

Each of first timing Tm1, second timing Tm2, third timing Tm3, and fourth timing Tm4 is an exposure timing controlled by light exposure control signal 7D. Signal controller 101 outputs light exposure control signal 7D corresponding to first timing Tm1 and second timing Tm2 in the first period, and outputs light exposure control signal 7D corresponding to third timing Tm3 and fourth timing Tm4 in the second period. FIG. 15 illustrates amount of light received R1 that is an amount of light received during first timing Tm1, amount of light received R2 that is an amount of light received during second timing Tm2, amount of light received R3 that is an amount of light received during third timing Tm3, and amount of light received R4 that is an amount of light received during fourth timing Tm4.

As illustrated in FIG. 15, the start time of third timing Tm3 which is based on third light emission control signal Es3 is different from the start time of first timing Tm1 which is based on first light emission control signal Es1, and is later than the start time of first timing Tm1 by time Δt. Also, the start time of fourth timing Tm4 which is based on fourth light emission control signal Es4 is different from the start time of second timing Tm2 which is based on second light emission control signal Es2, and is later than the start time of second timing Tm2 by time Δt. In other words, the difference between the start time of fourth timing Tm4 which is based on fourth light emission control signal Es4 and the start time of second timing Tm2 which is based on second light emission control signal Es2 is the same as the difference between the start time of third timing Tm3 which is based on third light emission control signal Es3 and the start time of first timing Tm1 which is based on first light emission control signal Es1.

First depth D1 and second depth D2 are calculated by signal processor 104 in the manner described below.

For example, first depth D1 is calculated based on a ratio between (i) amount of light received R1 that is an amount of light received by light receiver 103 through light exposure during first timing Tm1 in response to first light emission control signal Es1 output from signal controller 101 and (ii) amount of light received R2 that is an amount of light received by light receiver 103 through light exposure during second timing Tm2 in response to second light emission control signal Es2 output from signal controller 101. Note that second timing Tm2 is different from first timing Tm1 and starts later than first timing Tm1 by time Tᵣ.

Second depth D2 is calculated based on a ratio between amount of light received R3 that is an amount of light received by light receiver 103 through light exposure during third timing Tm3 in response to third light emission control signal Es3 output from signal controller 101; and amount of light received R4 that is an amount of light received by light receiver 103 through light exposure during fourth timing Tm4 in response to fourth light emission control signal Es4 output from signal controller 101. Note that fourth timing Tm4 is different from third timing Tm3 and starts later than third timing Tm3 by time Tᵣ.

Data holder 113 holds in advance reference data D_{ref} in a non-multipath environment. Reference data D_{ref} is data on depth. This data on depth is calculated based on a ratio between: an amount of light received by light receiver 103 through light exposure during a predetermined timing in response to a predetermined light emission control signal output from signal controller 101; and an amount of light received by light receiver 103 through light exposure during a timing different from the predetermined timing in response to a light emission control signal output from signal controller 101 in a time slot different from the time slot in which the predetermined light emission control signal is output.

Determiner 112 determines the presence or absence of multipath based on reference data D_{ref} and the difference between first depth D1 and second depth D2 output from signal processor 104. Specifically, determiner 112 calculates reference depth D_{ref}(α₀) in a non-multipath environment based on: depth slope α calculated based on the difference between first depth D1 and second depth D2; and reference data D_{ref} held by data holder 113. Determiner 112 then determines the presence or absence of multipath based on the magnitude of the difference between first depth D1 and reference depth D_{ref}(α₀).

When doing so, a difference between two depths can be used instead of depth slope α. Specifically, determiner 112 may calculate a reference depth in a non-multipath environment based on: the difference between first depth D1 and second depth D2; and reference data D_{ref} held by data holder 113, and determine the presence or absence of multipath based on the magnitude of the difference between first depth D1 and reference depth D_{ref}(α₀).

Note that, in the above example, the presence or absence of multipath is determined based on the magnitude of the difference between first depth D1 and reference depth D_{ref}(a₀); however, the present disclosure is not limited to this example, and the presence or absence of multipath may be determined based on the magnitude of the difference between second depth D2 and reference depth D_{ref}(α₀). Furthermore, reference data D_{ref} may be generated by an equation that uses Equations 12 and 13, or may be generated by actual measurement using different measurement target distances for the S0 exposure, S1 exposure, and BG exposure of the first period and for the S0 exposure, S1 exposure, and BG exposure of the second period described above.

### 1-2. Multipath Detection Method

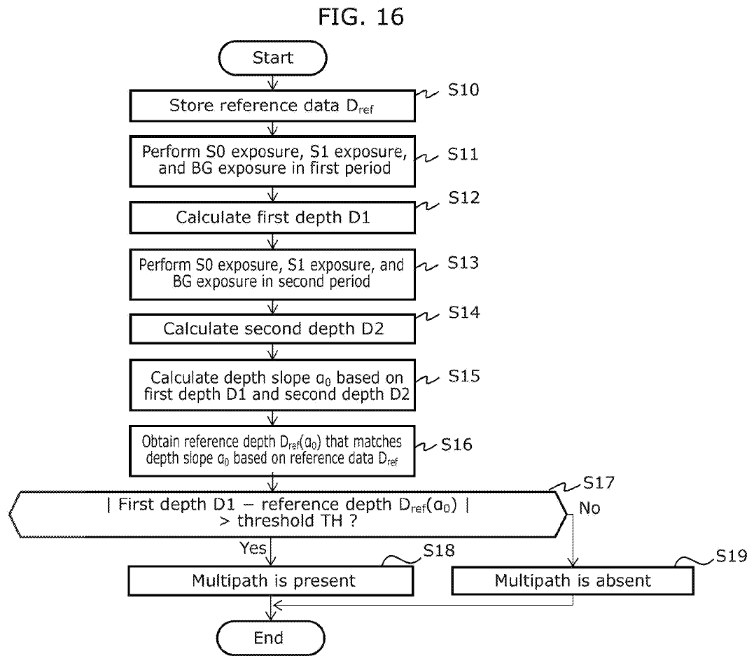

FIG. 16 is a flowchart illustrating a multipath detection method according to Working Example 1.

First, as preparation for multipath detection, multipath detection device 100 stores, in data holder 113, reference data D_{ref} in a non-multipath environment (Step S10). Reference data D_{ref} in a non-multipath environment is light reception signal sequence data obtained when only direct reflected light is received, and is shown by a graph of depth D and slope α generated with direct reflected light only, as exemplified by FIG. 7D.

Subsequently, multipath detection device 100 performs the S0 exposure, S1 exposure, and BG exposure in the first period (Step S11). Specifically, light receiver 103 obtains amount of light received R1 through light exposure during first timing Tm1, and obtains amount of light received R2 through light exposure during second timing Tm2. Amount of light received R1 and amount of light received R2 are output to signal processor 104.

Next, signal processor 104 calculates first depth D1 based on the ratio between amount of light received R1 and amount of light received R2 (Step S12). First depth D1 is calculated by determining the second term on the right side of Equation 1.

Subsequently, multipath detection device 100 performs the S0 exposure, S1 exposure, and BG exposure in the second period (Step S13). Specifically, light receiver 103 obtains amount of light received R3 through light exposure during third timing Tm3, and obtains amount of light received R4 through light exposure during fourth timing Tm4. Amount of light received R3 and amount of light received R4 are output to signal processor 104.

Next, signal processor 104 calculates second depth D2 using the ratio between amount of light received R3 and amount of light received R4 (Step S14), Second depth D2 is calculated by determining the second term on the right side of Equation 1, Note that Steps S13 and S14 may be performed prior to Steps S11 and S12.

Next, determiner 112 calculates depth slope α₀ based on first depth D1 and second depth D2 (Step S15). For example, determiner 112 calculates depth slope α₀ based on the difference between first depth D1 and second depth D2.

Subsequently, determiner 112 obtains reference depth D_{ref}(α₀) that matches depth slope α₀ (Step S16). Specifically, determiner 112 calculates reference depth D_{ref}(α₀) in a non-multipath environment based on depth slope α₀ described above and reference data D_{ref} held by data holder 113.

Subsequently, determiner 112 determines whether the magnitude of the difference between first depth D1 and reference depth D_{ref}(α₀) is greater than threshold TH (Step S17). Threshold TH is a standard for determining the margin of measurement error, and is freely set according to the allowable error required by a downstream system. For example, when the depth is in a range of from 0.0 to 1.0, threshold TH is set to 0.1 if the system allows a 10%-margin of error.

When the magnitude of the difference between first depth D1 and reference depth D_{ref}(α₀) is greater than threshold TH (Yes in S17), determiner 112 determines that multipath is present (Step S18). On the other hand, when the magnitude of the difference between first depth D1 and reference depth D_{ref}(α₀) is less than or equal to threshold TH (No in S17), determiner 112 determines that multipath is absent (Step S19). This way, whether or not multipath is present at the time of measuring the distance to the measurement target is determined.

When the multipath is determined to be absent, depth D and distance L can be calculated using Equations 12 to 14.

When the multipath is determined to be present, four unknown parameters shown below are calculated to correct depth D.

Of the four unknown parameters: the first one is light round-trip time t₁ that irradiation light takes to travel to the measurement target and travel back from the measurement target as direct reflected light; the second one is received-light intensity an of the direct reflected light at the start of falling; the third one is multipath delay time t_{b} of indirect reflected light with respect to light round-trip time t₁ of direct light; and the fourth one is received-light intensity bₜ₁ of indirect reflected light at the start of falling. Here, multipath delay time t_{b} is delay time in the case where the indirect reflected light travels back later than the direct reflected light, and thus t_{b}>0. In contrast, multipath advance time t_{b} illustrated in FIG. 12A is advance time in the case where the indirect reflected light travels back earlier than the direct reflected light, and thus t_{b}<0.

Here, four measurement values are used to calculate the four unknown parameters. The first value is first depth D1, the second value is second depth D2, and the third value is depth slope a calculated based on first depth D1 and second depth D2. The fourth value is luminance information that is output from signal processor 104, The luminance information may be first luminance B1 calculated from the first period, second luminance B2 calculated from the second period, or an average of first luminance B1 and second luminance B2.

Subsequently, four equations shown in Equations 24 to 27 are generated, and unknown parameters t₁, aₜ₁, bₜ₁, and t_{b} which make the solution of each equation zero are calculated. To solve the four equations, general non-linear estimation may be used, or other high-speed estimation methods may be used.

$$\begin{matrix}[ Formula 24 ] & \\ D 1 - \frac{{\int }_{{T}_{r}}^{{T}_{r} + 2 ( {T}_{r} + {T}_{f} )} \{ {R}_{direct} ( t ) + {R}_{indirect} ( t ) \} dt}{{\int }_{0}^{2 ( {T}_{r} + {T}_{f} )} \{ {R}_{direct} ( t ) + {R}_{indirect} ( t ) \} dt} = 0 & Equation 24 \\ [ Formula 25 ] & \\ D 2 - \frac{{\int }_{{T}_{r} + Δ t}^{{T}_{r} + 2 ( {T}_{r} + {T}_{f} ) + Δ t} \{ {R}_{direct} ( t ) + {R}_{indirect} ( t ) \} dt}{{\int }_{Δ t}^{2 ( {T}_{r} + {T}_{f} ) + Δ t} \{ {R}_{direct} ( t ) + {R}_{indirect} ( t ) \} dt} = 0 & Equation 25 \\ [ Formula 26 ] & \\ {α}_{0} - \frac{\begin{matrix}( \frac{{\int }_{{T}_{r}}^{{T}_{r} + 2 ( {T}_{r} + {T}_{f} )} \{ {R}_{direct} ( t ) + {R}_{indirect} ( t ) \} dt}{{\int }_{0}^{2 ( {T}_{r} + {T}_{f} )} \{ {R}_{direct} ( t ) + {R}_{indirect} ( t ) ] dt} - \\ \frac{{\int }_{{T}_{r} + Δ t}^{{T}_{r} + 2 ( {T}_{r} + {T}_{f} ) + Δ t} \{ {R}_{direct} ( t ) + {R}_{indirect} ( t ) \} dt}{{\int }_{Δ t}^{2 ( {T}_{r} + {T}_{f} ) + Δ t} \{ {R}_{direct} ( t ) + {R}_{indirect} ( t ) \} dt} )\end{matrix}}{Δ t} = 0 & Equation 26 \\ [ Formula 27 ] & \\ B 1 - ( {\int }_{0}^{2 ( {T}_{r} + {T}_{f} )} \{ {R}_{direct} ( t ) + {R}_{indirect} ( t ) \} dt ) = 0 & Equation 27\end{matrix}$$

Once unknown parameters t₁, aₜ₁, bₜ₁, and t_{b} are calculated, depth D in the case of a non-multipath environment can be calculated.

In such a manner, signal processor 104 calculates: first luminance B1 that is determined based on amount of light received R1 which is an amount of light received by light receiver 103 through light exposure during first timing Tm1; and second luminance B2 that is determined based on amount of light received R3 which is an amount of light received by light receiver 103 through light exposure during third timing Tm3. When multipath is determined to be present, determiner 112 corrects first depth D1 or second depth D2 using: at least one of first luminance B1 or second luminance B2; the difference between first depth D1 and second depth D2; and reference data D_{ref}, This makes it possible to calculate distance L in a multipath environment.

### 1-3. Variation of Working Example 1

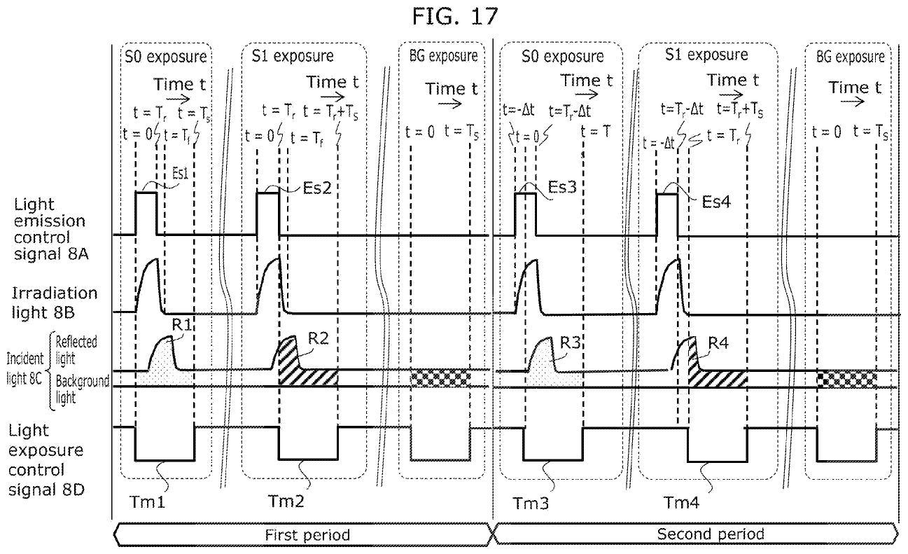

Next, multipath detection device 100 according to a variation of Working Example 1 will be described with reference to FIG. 17.

FIG. 17 is a timing diagram illustrating operations of multipath detection device 100 according to the variation of Working Example 1. FIG. 17 illustrates light emission control signal 8A, irradiation light 8B, incident light 8C, and light exposure control signal 8D.

The settings for the S0 exposure, S1 exposure, and BG exposure in the first period are the same as the settings for the exposures in FIG. 6.

The S0 exposure, S1 exposure, and BG exposure in the second period are the same as those in the first period in terms of the timing of light exposure control signal 8D, and are different from those in the first period in that light emission control signal 8A in the second period is earlier than light emission control signal 8A in the first period by Δt. As a result, the timings of irradiation light 8B and incident light 8C in the second period are also earlier than those in the first period by ΔT.

In the variation, too, first depth D1 is calculated based on the ratio between amount of light received R1 and amount of light received R2 illustrated in FIG. 17, and second depth D2 is calculated based on the ratio between amount of light received R3 and amount of light received R4. Then, the presence or absence of multipath can be determined based on reference data D_{ref} and the difference between first depth D1 and second depth D2.

### 1-4. Advantageous Effects, Etc

Multipath detection device 100 according to the present embodiment includes: signal controller 101 that outputs light emission control signal 7A and light exposure control signal 7D; light emitter 102 that emits light in accordance with light emission control signal 7A; light receiver 103 that receives light through light exposure in accordance with light exposure control signal 7D; data holder 113 that holds reference data D_{ref} on a depth determined based on a ratio between: an amount of light received by light receiver 103 through light exposure in a non-multipath environment during a predetermined timing in accordance with a predetermined light emission control signal output from signal controller 101; and an amount of light received by light receiver 103 through light exposure in the non-multipath environment during a timing different from the predetermined timing in accordance with a light emission control signal output from signal controller 101 in a time slot different from a time slot in which the predetermined light emission control signal is output; signal processor 104 that calculates first depth D1 and second depth D2, first depth D1 being determined based on a ratio between (i) amount of light received R1 that is an amount of light received by light receiver 103 through light exposure during first timing Trail in accordance with first light emission control signal Es1 output from signal controller 101 and (ii) amount of light received R2 that is an amount of light received by light receiver 103 through light exposure during second timing Tm2 different from first timing Tm1 in accordance with second light emission control signal Es1 output from signal controller 101 in a time slot different from a time slot in which first light emission control signal Es1 is output, second depth D2 being determined based on a ratio between (iii) amount of light received R3 that is an amount of light received by light receiver 103 through light exposure during third timing Tm3 in accordance with third light emission control signal Es3 output from signal controller 101 and (iv) amount of light received R4 that is an amount of light received by light receiver 103 through light exposure during fourth timing Tm4 different from third timing Tm3 in accordance with fourth light emission control signal Es4 output from signal controller 101 in a time slot different from a time slot in which third light emission control signal Es3 is output; and determiner 112 that determines the presence or absence of multipath using reference data D_{ref} and a difference between first depth D1 and second depth D2.

As described above, since signal processor 104 calculates first depth D1 based on the ratio between amount of light received R1 and amount of light received R2, and second depth D2 based on the ratio between amount of light received R3 and amount of light received R4, and determiner 112 determines the presence or absence of multipath based on reference data D_{ref} and the difference between first depth D1 and second depth D2, it is possible to reduce the processing load for the determination of the presence or absence of multipath.

Also, a waveform of irradiation light emitted by light emitter 102 may be a distorted pulse waveform that monotonically increases and then monotonically decreases.

This makes the relationship between depth and depth slope one-to-one, and the processing load for the multipath detection can be reduced.

Also, a start time of fourth timing Tm4 which is based on fourth light emission control signal Es4 may be different from a start time of second timing Tm2 which is based on second light emission control signal Es1.

With this, a TOF multipath detection device that adjusts the settings of the emission puke and the exposure pulse becomes capable of detecting multipath through extension of the standard functions, thus enabling cost reduction of multipath detection device 100.

Also, a start time of third timing Tm3 which is based on third light emission control signal Es3 may be different from a start time of first timing Trail which is based on first light emission control signal Es1.

With this, a TOF multipath detection device that adjusts the settings of the emission puke and the exposure pulse becomes capable of detecting multipath through extension of the standard functions, thus enabling cost reduction of multipath detection device 100.

Also, a difference between the start time of fourth timing Tm4 which is based on fourth light emission control signal Es4 and the start time of second timing Tm2 which is based on second light emission control signal Es1 may be identical to a difference between the start time of third timing Tm3 which is based on third light emission control signal Es3 and the start time of first timing Tm1 which is based on first light emission control signal Es1.

This makes it possible to accurately determine depths each calculated based on a ratio between two amounts of light received. Accordingly, the presence or absence of multipath can be accurately determined based on reference data D_{ref} and the difference between two depths.

Also, signal controller 101 may output first light emission control signal Es1 and third light emission control signal Es3 in different time slots.

This makes it possible to easily calculate first depth D1 and second depth D2, thus enabling reduction in the processing load for the determination of the presence or absence of multipath.

Also, data holder 113 may hold, as reference data D_{ref}, a relationship between the depth and a depth slope, and determiner 112 may calculate reference depth D_{ref}(α₀) in the non-multipath environment based on: depth slope α₀ calculated based on a difference between first depth D1 and second depth D2; and reference data D_{ref} held by data holder 113, and determine the presence or absence of the multipath based on a magnitude of a difference between reference depth D_{ref}(α₀) and one of first depth D1 and second depth D2.

In such a manner, by calculating reference depth D_{ref}(α₀) in a non-multipath environment based on depth slope α₀ and reference data D_{ref}, and determining the presence or absence of multipath based on the magnitude of the difference between, for example, first depth D1 and reference depth D_{ref}(α₀), it is possible to reduce the processing load for the determination of the presence or absence of multipath.

Also, determiner 112 may calculate reference depth D_{ref}(α₀) in the non-multipath environment based on: a difference between first depth D1 and second depth D2; and reference data D_{ref} held by data holder 113, and determine the presence or absence of the multipath based on a magnitude of a difference between reference depth D_{ref}(α₀) and one of first depth D1 and second depth D2.

In such a manner, by calculating reference depth D_{ref}(α₀) in a non-multipath environment based on reference data D_{ref} and the difference between two depths, and determining the presence or absence of multipath based on the magnitude of the difference between, for example, first depth D1 and reference depth D_{ref}(α₀), it is possible to reduce the processing load for the determination of the presence or absence of multipath.

Also, signal processor 104 may calculate first luminance B1 based on amount of light received R1 that is the amount of light received by light receiver 103 through light exposure during first timing Tm1, and second luminance B2 based on amount of light received R3 that is the amount of light received by light receiver 103 through light exposure during third timing Tm3, and when the multipath is determined to be present, determiner 112 may correct first depth D1 using: at least one of first luminance B1 or second luminance B2; the difference between first depth D1 and second depth D2; and reference data D_{ref}.

This makes it possible to calculate the depth with no measurement error caused by multipath, and measure the correct distance based on the calculated depth.

The multipath detection method according to the present embodiment includes: storing reference data D_{ref} on a depth determined based on a ratio between: an amount of light received through light exposure in a non-multipath environment during a predetermined timing in accordance with a predetermined light emission control signal; and an amount of light received through light exposure in the non-multipath environment during a timing different from the predetermined timing in accordance with a light emission control signal output in a time slot different from a time slot in which the predetermined light emission control signal is output; calculating first depth D1 based on a ratio between (i) amount of light received R1 that is an amount of light received through light exposure during first timing Tm1 in accordance with first light emission control signal Es1 and (ii) amount of light received R2 that is an amount of light received through light exposure during second timing Tm2 different from first timing Tm1 in accordance with second light emission control signal Es1 output in a time slot different from a time slot in which first light emission control signal Es1 is output; calculating second depth D2 based on a ratio between (iii) amount of light received R3 that is an amount of light received through light exposure during third timing Tm3 in accordance with third light emission control signal Es3 and (iv) amount of light received R4 that is an amount of light received through light exposure during fourth timing Tm4 different from third timing Tm3 in accordance with fourth light emission control signal Es4 output in a time slot different from a time slot in which third light emission control signal Es3 is output; and determining the presence or absence of multipath using reference data D_{ref} and a difference between first depth D1 and second depth D2.

As described above, by calculating first depth D1 based on the ratio between amount of light received R1 and amount of light received R2, and second depth D2 based on the ratio between amount of light received R3 and amount of light received R4, and determining the presence or absence of multipath based on reference data D_{ref} and the difference between first depth D1 and second depth D2, it is possible to reduce the processing load for the determination of the presence or absence of multipath.

### Working Example 2

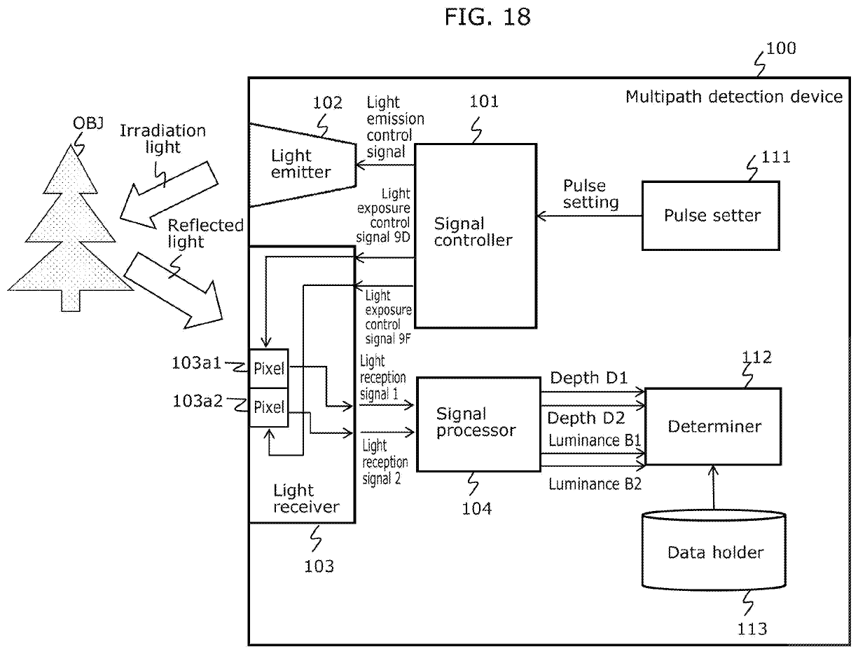

Next, multipath detection device 100 according to Working Example 2 will be described with reference to FIG. 18 to FIG. 20. While Working Example 1 has described the example in which the light exposures in the first period and the light exposures in the second period are performed in time sequence, Working Example 2 will describe an example in which the S0 exposures, S1 exposures, and BG exposures in the first and second periods are associated with two pixels and performed collectively.

FIG. 18 is a block diagram illustrating an exemplary configuration of multipath detection device 100 according to Working Example 2.

Signal controller 101 simultaneously generates and outputs timing signals corresponding to the first period and the second period in FIG. 17. For example, signal controller 101 outputs light exposure control signal 9D to first pixel 103a1 of light receiver 103, and outputs light exposure control signal 9F to second pixel 103a2 of light receiver 103.

Light receiver 103 includes first pixel 103a1 and second pixel 103a2. First pixel 103a1 activates upon reception of light exposure control signal 9D, and second pixel 103a2 activates upon reception of light exposure control signal 9F.

Signal processor 104 receives, from pixel 103a1, light reception signal 1 regarding an amount of light received, and calculates first depth D1 and first luminance B1. Signal processor 104 also receives, from pixel 103a2, light reception signal 2 regarding an amount of light received, and calculates second depth D2 and second luminance B2. Signal processor 104 then outputs information on first depth D1, second depth D2, first luminance B1, and second luminance B2 to determiner 112,

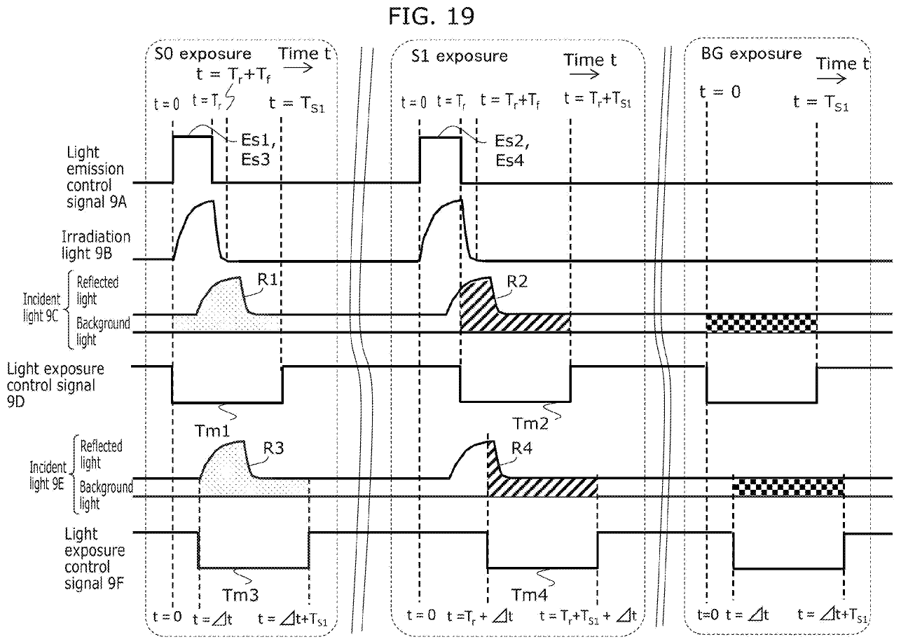

FIG. 19 is a timing diagram illustrating operations of multipath detection device 100 according to Working Example 2. FIG. 19 illustrates light emission control signal 9A, irradiation light 9B, incident light 9C, light exposure control signal 9D, incident light 9E, and light exposure control signal 9F. The settings for the timings indicated by light emission control signal 9A, irradiation light 9B, incident light 9C, and light exposure control signal 9D in FIG. 19 are the same as the settings for the timings in FIG. 6.

As illustrated in FIG. 19, first light emission control signal Es1 and third light emission control signal Es3 are simultaneously output, and second light emission control signal Es2 and fourth light emission control signal Es4 are simultaneously output.

Light exposure control signal 9D is output during first timing Tm1 which is based on first light emission control signal Es1, and light exposure control signal 9D is output during second timing Tm2 which is based on second light emission control signal Es2. Light exposure control signal 9F is output during third timing Tm3 which is based on third light emission control signal Es3, and light exposure control signal 9F is output during fourth timing Tm4 which is based on fourth light emission control signal Es4. The start time of third timing Tm3 is later than that of first timing Tm1 by time Δt, and the start time of fourth timing Tm4 is later than that of second timing Tm2 by time Δt. Furthermore, second timing Tm2 starts later than first timing Tm1 by time Tᵣ based on light emission control signal 9A, and fourth timing Tm4 starts later than third timing Tm3 by time Tᵣ based on light emission control signal 9A.

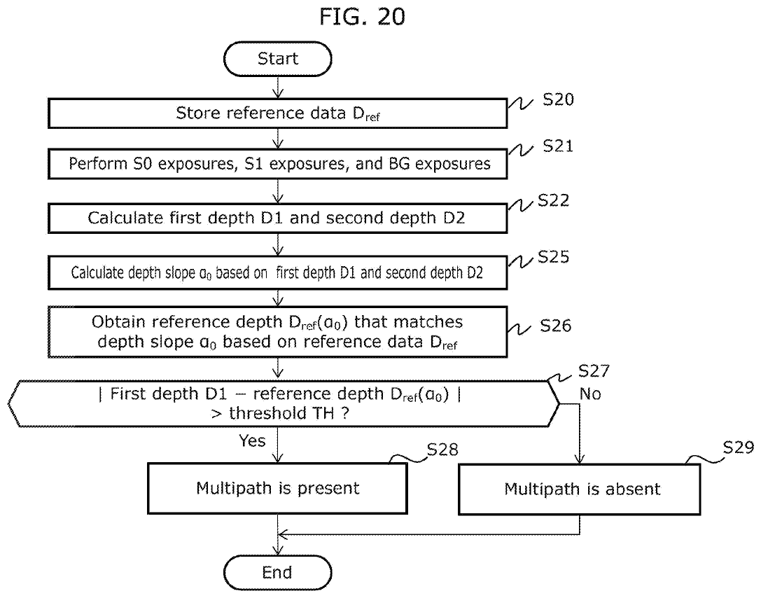

FIG. 20 is a flowchart illustrating a multipath detection method according to Working Example 2.

First, as preparation for multipath detection, multipath detection device 100 stores, in data holder 113, reference data D_{ref} in a non-multipath environment (Step S20).

Subsequently, multipath detection device 100 performs the S0 exposures, S1 exposures, and BG exposures corresponding to the first period and the second period (Step S21). Specifically, light receiver 103 obtains amount of light received R1 through light exposure during first timing Tm1, obtains amount of light received R2 through light exposure during second timing Tm2, obtains amount of light received R3 through light exposure during third timing Tm3, and obtains amount of light received R4 through light exposure during fourth timing Tm4. Amounts of light received R1 to R4 are output to signal processor 104.

Next, signal processor 104 calculates first depth D1 based on the ratio between amount of light received R1 and amount of light received R2, and calculates second depth D2 based on the ratio between amount of light received R3 and amount of light received R4 (Step S22).

Next, determiner 112 calculates depth slope α₀ based on first depth D1 and second depth D2 (Step S25). For example, determiner 112 calculates depth slope α₀ based on the difference between first depth D1 and second depth D2.

Subsequently, determiner 112 obtains reference depth D_{ref}(α₀) that matches depth slope α₀ (Step S26), Specifically, determiner 112 calculates reference depth D_{ref}(α₀) in a non-multipath environment based on depth slope α₀ described above and reference data D_{ref} held by data holder 113.

Subsequently, determiner 112 determines whether the magnitude of the difference between first depth D1 and reference depth D_{ref}(α₀) is greater than threshold TH (Step S27).

When the magnitude of the difference between first depth D1 and reference depth D_{ref}(α₀) is greater than threshold TH (Yes in S27), determiner 112 determines that multipath is present (Step S28). On the other hand, when the magnitude of the difference between first depth D1 and reference depth D_{ref}(α₀) is less than or equal to threshold TH (No in S27), determiner 112 determines that multipath is absent (Step S29). This way, whether or not multipath is present at the time of measuring the distance to the measurement target is determined.

When the multipath is determined to be absent, depth D and distance L can be calculated using Equations 12 to 14.

When the multipath is determined to be present, correction can be carried out based on the above-described depths, luminance, and slope in the same manner as in Working Example 1. In addition, it is possible to obtain a necessary light reception signal with less frames than in Working Example 1, and perform multipath detection and correction at high speed.

In such a manner as described above, multipath detection device 100 according to Working Example 2 calculates first depth D1 based on the ratio between amount of light received R1 and amount of light received R2 illustrated in FIG. 19, and calculates second depth D2 based on the ratio between amount of light received R3 and amount of light received R4. Since the presence or absence of multipath is determined based on reference data D_{ref} and the difference between first depth D1 and second depth D2, it is possible to reduce the processing load for the determination of the presence or absence of multipath.

Signal controller 101: simultaneously outputs first light emission control signal Es1 and third light emission control signal Es3; simultaneously outputs second light emission control signal Es1 and fourth light emission control signal Es4; outputs, to first pixel 103a1 of light receiver 103, light exposure control signal 9D for performing light exposure in response to first light emission control signal Es1 and light exposure in response to second light emission control signal Es1; and outputs, to second pixel 103a2 of light receiver 103, light exposure control signal 9F for performing light exposure in response to third light emission control signal Es3 and light exposure in response to fourth light emission control signal Es4.

This makes it possible to simultaneously perform the processing in the first period and the processing in the second period using two pixels, thus simplifying the real-time processing for multipath detection.

### Other Embodiments

Although an embodiment has been described above, the present disclosure is not limited to the above embodiment. The present disclosure also encompasses embodiments achieved by making various modifications to the above embodiment that are conceivable to a person of skill in the art, as well as embodiments realized by arbitrarily combining constituent elements and functions of the above embodiment within the scope of the essence of the present disclosure.

Although only an exemplary embodiment of the present disclosure has been described in detail above, those skilled in the art will readily appreciate that many modifications are possible in the exemplary embodiment without materially departing from the novel teachings and advantages of the present disclosure. Accordingly, all such modifications are intended to be included within the scope of the present disclosure.

### INDUSTRIAL APPLICABILITY

The multipath detection device and multipath detection method according to the present disclosure are widely applicable to a TOF camera system, for example.

1. A multipath detection device, comprising:
a signal controller that outputs a light emission control signal and a light exposure control signal;
a light emitter that emits light in accordance with the light emission control signal;
a light receiver that receives light through light exposure in accordance with the light exposure control signal;
a data holder that holds reference data on a depth determined based on a ratio between: an amount of light received by the light receiver through light exposure in a non-multipath environment during a predetermined timing in accordance with a predetermined light emission control signal output from the signal controller; and an amount of light received by the light receiver through light exposure in the non-multipath environment during a timing different from the predetermined timing in accordance with the light emission control signal output from the signal controller in a time slot different from a time slot in which the predetermined light emission control signal is output;
a signal processor that calculates a first depth and a second depth, the first depth being determined based on a ratio between (i) an amount of light received by the light receiver through light exposure during a first timing in accordance with a first light emission control signal output from the signal controller and (ii) an amount of light received by the light receiver through light exposure during a second timing different from the first timing in accordance with a second light emission control signal output from the signal controller in a time slot different from a time slot in which the first light emission control signal is output, the second depth being determined based on a ratio between (iii) an amount of light received by the light receiver through light exposure during a third timing in accordance with a third light emission control signal output from the signal controller and (iv) an amount of light received by the light receiver through light exposure during a fourth timing different from the third timing in accordance with a fourth light emission control signal output from the signal controller in a time slot different from a time slot in which the third light emission control signal is output; and
a determiner that determines presence or absence of multipath using the reference data and a difference between the first depth and the second depth.

2. The multipath detection device according to claim 1, wherein
a waveform of irradiation light emitted by the light emitter is a distorted pulse waveform that monotonically increases and then monotonically decreases.

3. The multipath detection device according to claim 1, wherein
a start time of the fourth timing which is based on the fourth light emission control signal is different from a start time of the second timing which is based on the second light emission control signal.

4. The multipath detection device according to claim 3, wherein
a start time of the third timing which is based on the third light emission control signal is different from a start time of the first timing which is based on the first light emission control signal.

5. The multipath detection device according to claim 4, wherein
a difference between the start time of the fourth timing which is based on the fourth light emission control signal and the start time of the second timing which is based on the second light emission control signal is identical to a difference between the start time of the third timing which is based on the third light emission control signal and the start time of the first timing which is based on the first light emission control signal.

6. The multipath detection device according to claim 1, wherein
the signal controller outputs the first light emission control signal and the third light emission control signal in different time slots.

7. The multipath detection device according to claim 1, wherein
the signal controller:
simultaneously outputs the first light emission control signal and the third light emission control signal;
simultaneously outputs the second light emission control signal and the fourth light emission control signal;
outputs, to a first pixel of the light receiver, the light exposure control signal for performing light exposure in response to the first light emission control signal and light exposure in response to the second light emission control signal; and
outputs, to a second pixel of the light receiver, the light exposure control signal for performing light exposure in response to the third light emission control signal and light exposure in response to the fourth light emission control signal.

8. The multi path detection device according to claim 1, wherein
the data holder holds, as the reference data, a relationship between the depth and a depth slope, and
the determiner calculates a reference depth in the non-multipath environment based on: a depth slope calculated based on a difference between the first depth and the second depth; and the reference data held by the data holder, and determines the presence or absence of the multipath based on a magnitude of a difference between the reference depth and one of the first depth and the second depth.

9. The multipath detection device according to claim 1, wherein
the determiner calculates a reference depth in the non-multipath environment based on: a difference between the first depth and the second depth; and the reference data held by the data holder, and determines the presence or absence of the multipath based on a magnitude of a difference between the reference depth and one of the first depth and the second depth.

10. The multipath detection device according to claim 1, wherein
the signal processor calculates a first luminance based on the amount of light received by the light receiver through light exposure during the first timing, and a second luminance based on the amount of light received by the light receiver through light exposure during the third timing, and
when the multipath is determined to be present, the determiner corrects the first depth using: at least one of the first luminance or the second luminance; the difference between the first depth and the second depth; and the reference data.

11. A multipath detection method, comprising:
storing reference data on a depth determined based on a ratio between: an amount of light received through light exposure in a non-multipath environment during a predetermined timing in accordance with a predetermined light emission control signal; and an amount of light received through light exposure in the non-multipath environment during a timing different from the predetermined timing in accordance with a light emission control signal output in a time slot different from a time slot in which the predetermined light emission control signal is output;
calculating a first depth based on a ratio between (i) an amount of light received through light exposure during a first timing in accordance with a first light emission control signal and (ii) an amount of light received through light exposure during a second timing different from the first timing in accordance with a second light emission control signal output in a time slot different from a time slot in which the first light emission control signal is output;
calculating a second depth based on a ratio between (iii) an amount of light received through light exposure during a third timing in accordance with a third light emission control signal and (iv) an amount of light received through light exposure during a fourth timing different from the third timing in accordance with a fourth light emission control signal output in a time slot different from a time slot in which the third light emission control signal is output; and
determining presence or absence of multipath using the reference data and a difference between the first depth and the second depth.
